(19) United States
(12) Patent Application Publication
(10) Pub. No.: US 2012/0191267 A1
(43) Pub. Date: Jul. 26, 2012

(54) INFORMATION INPUT APPARATUS

(75) Inventors: Hiroaki Ogawa, Nagoya-city (JP); Kenji Ishida, Nagoya-city (JP)

(73) Assignee: DENSO CORPORATION, Kariya-city (JP)

(21) Appl. No.: 13/353,640

(22) Filed: Jan. 19, 2012

(30) Foreign Application Priority Data
Jan. 20, 2011 (JP) 2011-9944

(51) Int. Cl. G06F 7/00

(52) U.S. Cl. 701/1

(57) ABSTRACT

An information input apparatus for detecting input information to output operation information to a controlled apparatus is disclosed. The information input apparatus includes a steering device having a grip part and multiple connection parts connecting the grip part and a rotation shaft. A vehicle driver inputs the input information by tapping the grip part or the connection parts. The information input apparatus further includes multiple measurement devices for measuring the vibration propagating through the respective connection parts. A controller of the information input apparatus pre-stores a correspondence between a form of the vibration, which is measured with the measurement devices, and the operation information. The controller selects the operation information from the pre-stored correspondence based on measurement signals outputted from the two measurement devices.

### CROSS REFERENCE TO RELATED APPLICATION

The present application is based on and claims priority to Japanese Patent Application No. 2011-9944 filed on Jan. 20, 2011, disclosure of which is incorporated herein by reference.

### TECHNICAL FIELD

The present disclosure relates to an information input apparatus adapted to be mounted to a steering wheel of a vehicle.

### BACKGROUND

In recent years, the types of in-vehicle apparatuses equipped in a vehicle such as an automobile and the like, including a car stereo system, a car navigation system etc., are increasing. Accordingly, an information input manner of operating these in-vehicle apparatuses is becoming complicated. For example, when multiple buttons are arranged to correspond to types of operation on an in-vehicle apparatus, a driver who operates the in-vehicle apparatus needs to press multiple buttons in turn in an order of operation. In this case, a burden on the driver is disadvantageously large. Additionally, for a long period of time, the driver may continue to steer the vehicle with one hand while the other hand of the driver is being used to input operation information to an in-vehicle apparatus. In this case, the burden on the driver further increases.

For addressing the above problem, an information input apparatus that enables a driver to input the operation information to the in-vehicle apparatus without releasing his or her hands from the steering wheel has been proposed (see JP-2000-228126A and JP-2009-262710A for example).

JP-2000-228126A discloses a steering input apparatus including a piezoelectric sensor that is mounted to a grip portion (a portion to be gripped by the driver) of the steering wheel. This steering input apparatus can identify the inputted operation information based on how a load is applied to the steering wheel or a magnitude of the load, and can output multiple kinds of the operation information to the in-vehicle apparatus.

JP-2009-262710A discloses an information input apparatus including a sound wave detector that detects a sound wave propagating through the steering wheel. This information input apparatus determines a tapped location on the steering wheel based on a difference between a detection time of the sound wave propagating through the steering wheel in a clockwise direction and a detection time of the sound wave propagating through the steering wheel in a anticlockwise direction. The information input apparatus of JP-2009-262710A associates the tapped location on the steering wheel with the operation information outputted to the in-vehicle apparatus. Thereby, with use of the information input apparatus, desired operation information can be outputted to an in-vehicle apparatus.

In the information input apparatus of JP-2009-262710A, the sound wave detector is attachable (as an aftermarket part) to the steering wheel. Thus, without alternation or design change to an existing steering wheel, the information input apparatus of JP-2009-262710A can be easily attached. If unnecessary, the information input apparatus can be detached from the steering wheel.

The steering input apparatus of JP-2000-228126A requires that a piezoelectric sensor be mounted in the grip portion of the steering wheel. Thus, a large design change to an existing steering wheel is required. When the steering input apparatus of JP-2000-228126A is applied to an existing vehicle presently owned by a driver, a large alternation is required.

When inputted operation information is identified based on how the load is applied to the steering wheel or a magnitude of the load in a manner as described in JP-2000-228126A, an erroneous input may easily occur. For example, a driver's action for steering the vehicle such as turning the steering wheel may apply a load to the steering wheel, and this load may be erroneously detected by the steering input apparatus as an input of the operation information.

The information input apparatus of JP-2009-262710A is detachably attached to the steering wheel. Thus, the information input apparatus is arranged to project from the steering wheel. Therefore, n when the driver turns the steering wheel, the projecting information input apparatus may disturb the steering operation.

Additionally, in an information input apparatus like that described in JP-2009-262710A, when the steering wheel is tapped, the sound wave is generated and propagates through the steering wheel. The tapped location on a steering wheel is determined based on a time difference between when the sound wave propagates through the steering wheel in a clockwise direction reaches a sound wave detector and when the sound wave propagates through the steering wheel in an anticlockwise direction reaches the sound wave detector. In other words, the tapped location is determined based on a time difference between a first wave, which arrives at the sound detector first, and a second wave, which arrives at the sound detector later. However, according to this determination manner, it is difficult to determine the tapped location for the following reason.

Specifically, a steering wheel is provided with a spoke connecting the steering wheel and an axle shaft, which is typically located at a center of the steering wheel. This spoke damps a sound wave propagating through the steering wheel. Because of this, the amplitude of the second wave, which travels a relatively large distance on the steering wheel, tends to be smaller than that of the first wave. Accordingly, it is difficult for the sound detector to detect the amplitude of the second wave. As a result, it becomes difficult to measure a difference in detection time between the first wave and the second wave, and it becomes difficult to determine the tapped location on the steering wheel.

JP-2009-262710A further describes a method for determining the tapped location on the steering wheel. This method includes pattern matching on waveform of the sound wave detected with the sound wave detector. However, even in cases where the same location on the steering wheel is tapped, there is a variation of the waveform of the sound wave detected with the sound wave detector. Furthermore, noise such as vibrations of the vehicle is contained in the second wave. Therefore, the method of JP-2009-262710A has a difficulty in determining the tapped location on the steering wheel.

### SUMMARY

In view of the foregoing, it is an objective of the present disclosure to provide an information input apparatus that can be easily mounted and can suppress an erroneous input of operation information.

According to an example of the present disclosure, an information input apparatus for detecting input information to output operation information to a controlled apparatus is provided. The information input apparatus includes a steering device that includes a rotation shaft, a grip part and at least two connection parts. The rotation shaft is supported rotatably around an axis line. The grip part is grippable by a driver and rotatable around the axis line to steer a vehicle. Each of the at least two connection parts connects the grip part and the rotation shaft, and enables transmission of vibration with the grip part. A driver of the vehicle can input the input information by tapping the grip part or the at least two connection part of the steering device of the vehicle. The information input apparatus further includes at least two measurement devices and a controller. The at least two measurement devices are mounted to the at least two connection parts, respectively, and are configured to measure the vibration propagating through the at least two connection parts, thereby outputting measurement signals, respectively. The controller pre-stores a correspondence between a form of the vibration, which is measured with the at least two measurement devices, and operation information directed to a controlled apparatus. From the pre-stored correspondence, the controller selects the operation information directed to the controlled apparatus, based on the measurement signals outputted from the at least two measurement devices. The controller outputs a control signal associated with the selected operation information.

According to the above information input apparatus, the measurement devices can be easily mounted. An erroneous input of operation information can be suppressed.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a diagram illustrating an information input apparatus of a first embodiment;

FIG. 2 is a diagram illustrating a configuration of a steering device, and an arrangement of sensor devices;

FIG. 3 is a perspective view illustrating an arrangement of sensor devices;

FIG. 4 is a sectional view illustrating an attachment state of a sensor device;

FIG. 5 is a flowchart illustrating a control operation which is performed by an information input apparatus to control an in-vehicle apparatus;

FIG. 6 is a flowchart illustrating content of a sensitivity change process;

FIG. 7 is a flowchart illustrating content of a spoke tap estimation process;

FIG. 8 is a diagram for explanation on the content of the spoke tap estimation process;

FIG. 9 is a diagram for explanation on a process of removing a noise component;

FIG. 10 is a flowchart illustrating content of an in-vehicle apparatus control process;

FIG. 11 is a flowchart illustrating content of a wheel tap estimation process;

FIG. 12 is a diagram illustrating a relation between a tapped place of a steering wheel and an order in which vibration is measured with input sensor devices;

FIGS. 13A to 13F are diagrams illustrating a correspondence among a tapped place of a steering wheel, a control target etc., in the in-vehicle apparatus control process;

FIG. 14 is a flowchart illustrating content of a safety situation determination process;

FIG. 15 is a diagram illustrating a switching of an in-vehicle apparatus in a control target switching process;

FIG. 16 is a flowchart illustrating content of a setting change process;

FIG. 17 is a diagram for explanation on an experiment about arrangement positions of input sensor devices;

FIG. 18 is a diagram illustrating voltages of measurement signals outputted from input sensor devices arranged at positions shown in FIG. 17;

FIG. 19 is a diagram for explanation on an experiment about a contact surface between an input sensor device and a spoke;

FIG. 20 is a diagram illustrating voltages of measurement signals outputted from input sensor devices shown in FIG. 19;

FIG. 21 is a diagram illustrating a steering device of another embodiment;

FIG. 22 is a diagram illustrating a relation between a tapped place of the steering device of FIG. 21 and an order in which the vibration is measured with multiple input sensor devices;

FIG. 23 is a flowchart illustrating content of a wheel tap estimation process of a second embodiment;

FIG. 24 is a flowchart illustrating an amplitude value calculation process;

FIG. 25 is a graph for explanation on the content of the amplitude value calculation process;

FIG. 26 is a graph for explanation on calculation of amplitude value when a right portion is tapped; and

FIG. 27 is a graph for explanation on calculation of amplitude value when an upper portion is tapped.

### DETAILED DESCRIPTION

### First Embodiment

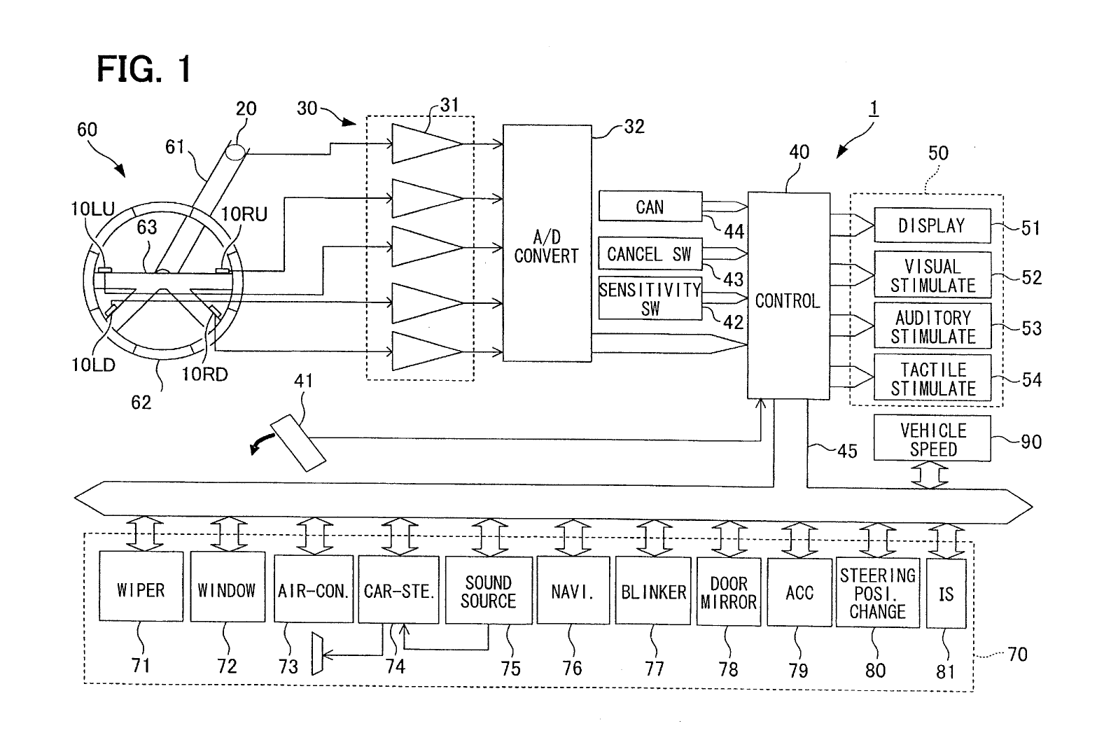

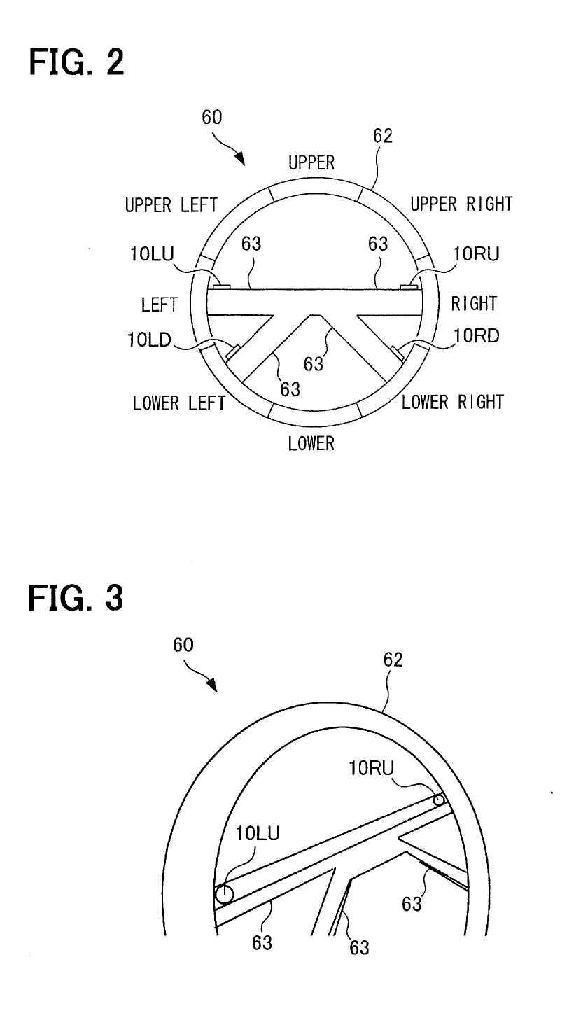

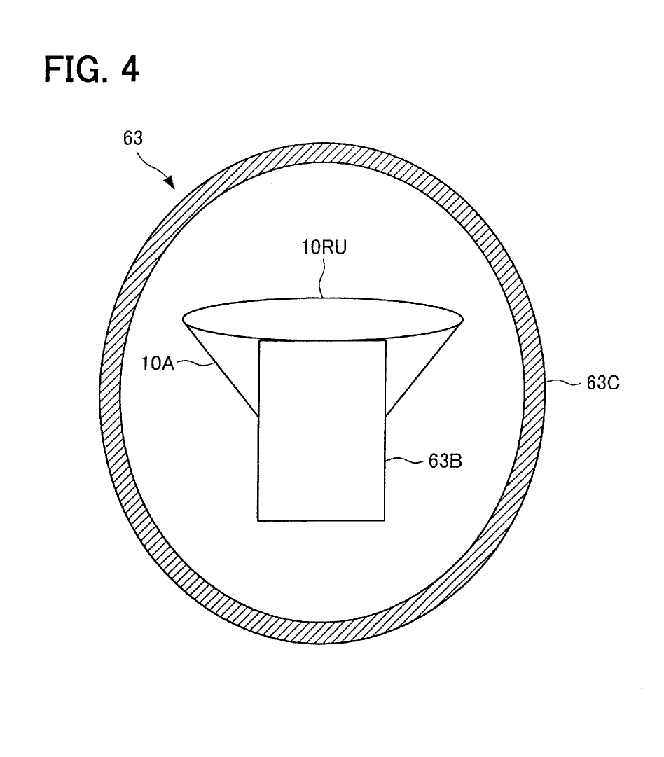

An information input apparatus 1 of a first embodiment will be described with reference to FIGS. 1 to 22. FIG. 1 is a diagram illustrating an information input apparatus 1 of the present embodiment. FIGS. 2 and 3 are diagrams illustrating a configuration of a steering device 60 and an arrangement of a sensor device. FIG. 4 is a sectional diagram illustrating an state where a sensor device is attached to a spoke 63.

As shown in FIG. 1, the information input apparatus 1 of the present embodiment is mounted to a steering device 60, which is used to steer a vehicle. The information input apparatus 1 is used to operate various in-vehicle apparatuses (referred to hereinafter as an apparatus to be controlled, and/or a controlled apparatus).

As shown in FIG. 1, the information input apparatus 1 includes input sensor devices 10RU, 10LU, 10RD, 10LD, a noise sensor device 20, a signal processing device 30, a controller 40, and a feedback device. The input sensor devices 10RU, 10LU, 10RD, 10LD is used to input operation information. The noise sensor device 20 is used to cancel noise. The signal processing device 30 performs processing on signals outputted from the input sensor devices 10RU, 10LU, 10RD, 10LD and the noise sensor device 20. The controller 40 determines the operation information corresponding to a vibration based on the processed signal and outputs a control signal to the in-vehicle apparatus 70. The feedback device 50 informs the driver of an operational state of the in-vehicle apparatus. In the above, the input sensor devices 10RU, 10LU, 10RD, 10LD is an example of a measurement device. The feedback device 50 is an example of an information providing device.

The steering device 60 includes, as shown in FIGS. 1 to 3, a steering shaft (rotation shaft) 61 which is rotatably supported around an axis line, a steering wheel (grip part) 62 which is formed in an annular shape, and a spoke 63 which connects the steering shaft 61 and the steering wheel 62. The present embodiment is directed to an example where the information input apparatus 1 is mounted to the steering device 60 with four spokes 63 arranged in a π-like shape. In the above, the steering wheel 62 is an example of a grip part of the steering device. The spoke 63 is an example of a connection part of the steering device.

The steering wheel 62 is grippable by the driver. The driver can steer the vehicle by rotating the steering wheel 62 around the steering shaft. A framework of the steering wheel 62 and the spoke 63 is made of metal such as iron and the like, and is arranged at a center in its cross section. A material having elasticity is arranged around the framework, and a cover is arranged on an outer surface. Rotation of the steering wheel 62 is transmitted to the steering shaft 61 via the spoke 63, and transmitted from the steering shaft 61 to a steering mechanism (not shown) of the vehicle.

As shown in FIG. 1, each of the input sensor devices 10RU, 10LU, 10RD, 10LD and the noise sensor device 20 uses a piezoelectric element to convert the vibration into an electric signal, and outputs the electric signal as a measurement signal to the signal processing device 30.

As shown in FIG. 1 and FIG. 2, the input sensor devices 10RU, 10LU, 10RD and 10LD are mounted to respective spokes 63 of the steering device 60, and are provided to measure vibrations of the spokes 63. In order to detect the vibrations conducting from the steering wheel 62 to the spokes 63, it may be preferable that the input sensor devices 10RU, 10LU, 10RD and 10LD be arranged in vicinity of portions of the spokes 63 connecting the steering wheel 62. As shown in FIG. 3 and FIG. 4, in order to improve vibration measurement sensitivity, the input sensor device 10RU, 10LU, 10RD, 10LD are arranged on upper surfaces of the frameworks of the spokes 63. Because of this, the input sensor devices 10RU, 10LU, 10RD, 10LD are covered with a cover 63C or the like and are not viewable from an outside. As an example, the input sensor device 10RU is shown in FIG. 4.

An auxiliary part 10A for assisting conduction of the vibration from the framework 63B to each input sensor device 10RU, 10LU, 10RD, 10LD is mounted to the framework 63B. The auxiliary part 10A is attached so that the auxiliary part 10A can conduct the vibration to the framework 63B and to the input sensor device 10RU, 10LU, 10RD, 10LD. In an example of the present embodiment, the vibration can conduct between the auxiliary part 10A and a whole surface, which faces the framework 63B, of the input sensor device 10RU, 10LU, 10RD, 10LD. The auxiliary part 10A may include, for example, an adhesive.

In an example of the present embodiment, as shown in FIG. 4, the auxiliary part 10A is shaped so that its cross section increases in a direction from the framework 63B toward the input sensor device 10RU, 10LU, 10RD, 10LD. However, this is merely an example, and does not limit the present embodiment. For example, the auxiliary part 10A may be shaped so that its cross section is approximately constant, for example, in the direction from the framework 63B toward the input sensor device 10RU, 10LU, 10RD, 10LD. Additionally, a whole surface, which faces the framework 63B, of the input sensor device 10RU, 10LU, 10RD, 10LD may contact with the auxiliary part 10A so that the whole surface can conduct the vibration to the auxiliary part 10A. Alternatively, a portion of the facing surface, which faces of the framework 63B, of the input sensor device 10RU, 10LU, 10RD, 10LD may contact with the auxiliary part 10A so that the portion of the facing surface can conduct the vibration to the auxiliary part 10A and that the portion of the facing surface is larger in area than a surface contacting the framework 63B.

Moreover, in order to improve the vibration measurement sensitivity, it may be preferable to arrange the input sensor device 10RU, 10LU, 10RD so that the whole surface of the input sensor device 10RU, 10LU, 10RD, 10LD contacts with the spoke 63 to conduct the vibration of the spoke to the input sensor device 10RU, 10LU, 10RD, 10LD.

In an example of the present embodiment, the input sensor device 10RU is mounted to the spoke 63 that extends toward the right when viewed from the driver. The input sensor device 10LU is mounted to the spoke 63 that extends toward the left when viewed from the driver. The input sensor device 10RD is mounted to the spoke 63 that extends toward the lower right when viewed from the driver. The input sensor device 10RU is mounted to the spoke 63 that extends toward the lower left when viewed from the driver.

As shown in FIG. 1, the noise sensor device 20 is mounted to the steering shaft 61 of the steering device 60 and measures the vibration of the steering shaft 61. A main component of the vibration of the steering shaft 61 is a vibration that is generated from a driving system, a vibration that is generated from shock or the like from a road surface when the vehicle is traveling, and the like. The vibration acting as noise, which is other than the vibration that is intentionally generated by the driver to operate the in-vehicle apparatus 70, constitutes a majority of the vibration of the steering shaft 61.

The signal processing device 30 performs signal processing on the measurement signals outputted from the input sensor devices 10RU, 10LU, 10RD, 10LD and the noise sensor device 20, so that the processed signals have a from imputable to the controller 40. As shown in FIG. 1, the signal processing device 30 includes an amplifier 31 for amplifying the amplitude of the measurement signal and an analog digital (A/D) convertor 32 for converting the measurement signal, which is an analog signal, into a digital signal. Types of the amplifier 31 and the A/D converter 32 may not be limited. A known amplifier and a known A/D converter may be used.

The controller 40 includes a processing unit and a built-in storage device. The processing unit reads and executes various programs stored in the built-in storage device, and thereby performing a variety of information processing. In the present embodiment, based on the measurement signals outputted from the input sensor devices 10RU, 10LU, 10RD, 10LD, the controller 40 determines which portion (place) of the steering wheel 62 and the spokes 63 of the steering device 60 the driver has tapped, and, the controller 40 identifies the operation information corresponding to the determined tapped place and outputs a control signal associated with the identified operation information to the in-vehicle apparatus 70. Furthermore, the controller 40 receives a signal indicating an operational state from the in-vehicle apparatus 70 to which the controller 40 has outputted the control signal. The controller 40 outputs a control signal to the feedback device 50 to notify the driver of the operational state.

Signals from a footrest switch 41, a sensitivity switch 42 and a cancel switch 43 are inputted to the controller 40 in addition to a signal from the above-described signal processing device 30. A signal relating to vehicle speed is inputted to the controller 40 via a controller area network (CAN) 44.

The footrest switch 41 can be used to switch operation content on the in-vehicle apparatus 70 between operation control and setting change. When the driver presses down the footrest switch 41 with his or her foot, a selection signal for switching into an operation control mode or a setting change mode is outputted to the controller 40. The operation control mode is a mode where an operation of the in-vehicle apparatus 70 is changed. The setting change mode is a mode where a setting is changed. For example, each time when the footrest switch 41 is pressed, the mode is alternately switched into the operation control mode and the setting change mode.

The sensitivity switch 42 can be used to control input sensitivity of the information input apparatus 1. This input sensitivity is sensitivity to an input of the operation information. Specifically, the sensitivity switch 42 is used to control magnitude of the amplitude of the vibration of the steering wheel 62 and/or the spokes 63 that the information input apparatus 1 can be sensed. In other words, the sensitivity switch 42 is used to control the magnitude of a tapping force that is required when the operation information is inputted to the information input apparatus 1.

The sensitivity switch 42 is used to switch an input sensitivity setting manner between a manual setting mode and an automatic setting mode. When the input sensitivity setting manner is switched into the manual setting mode, the information input apparatus 1 can set a lower limit of input sensitivity to the input of the operation information. In other words, a minimum amount (least amount) of the tapping force required in inputting the operation information can be set. When the input sensitivity setting mode is switched into the automatic setting mode, the minimum amount of the tapping force required in inputting the operation information is automatically changed according to traveling speed of the vehicle.

The cancel switch 43 outputs a signal for canceling a start of an operation of the in-vehicle apparatus 70. Specifically, the cancel switch 43 can be used to cancel, before the in-vehicle apparatus 70 starts an operation based on the inputted information, the start of the operation. For example, when the driver presses the cancel switch 43, the cancel switch 43 outputs a cancel signal to the controller 40. In this case, if the control signal associated with the operation information has not been outputted to the in-vehicle apparatus 70 yet, the controller 40 cancel an output of the control signal. If the control signal associated with the operation information has been outputted to the in-vehicle apparatus 70 already, the controller 40 outputs a control signal to the in-vehicle apparatus 70 instructing the cancellation of the operation that is based on the operation information.

The CAN 44 is an in-vehicle network that enables multiplex communications between a variety of parts mounted to the vehicle to exchange signals with each other. In an example of the present embodiment, a vehicle speed sensor 90 for measuring the travel speed of the vehicle outputs a speed signal, which is inputted to the controller 40 via the CAN 44. The vehicle seed sensor 90 can act as a travelling state detector.

A bus 45 for control (also referred to as a control bus) is provided between the controller 40 and the in-vehicle apparatus 70. The control bus 45 can conduct the control signal outputted from the controller 40 to the in-vehicle apparatus 70. The control bus 45 can further conduct a signal indicative of the operational state outputted from the in-vehicle apparatus 70 to the controller 40.

The feedback device 50 transmits a variety of information to the driver. The feedback device 50 operates based on a control signal outputted from the controller 40. In the present embodiment, the feedback device 50 includes a display 51, a visual sense stimulator 52, an auditory sense stimulator 53, and a tactile sense stimulator 54. The display 51 displays the operational state of the in-vehicle apparatus 70 as an image. The visual sense stimulator 52 includes a light source or the like, and informs the operational state of the in-vehicle apparatus 70 by appealing to a visual sense of the driver, e.g., blinking the light. The auditory sense stimulator 53 includes a speaker or the like, and informs the operational state of the in-vehicle apparatus 70 by appealing to an auditory sense of the driver, e.g., outputting speech. The tactile sensor stimulator 54 includes, for example, a vibration generator mounted to the steering wheel 62. The tactile sensor stimulator 54 informs the operational state of the in-vehicle apparatus by appealing to a tactile sense of the driver by means of, for example, vibration. It should be noted that the above parts 51 to 54 are merely examples. All of the display 51, the visual sense stimulator 52, the auditory sense stimulator 53 and the tactile sensor stimulator 54 may not be included in the feedback device 50. The feedback device 50 may include a part other than the above-described parts 51 to 54.

As shown in FIG. 1, the in-vehicle apparatus 70 of the present embodiment includes a wiper 71, a power window 72 (which can be closed and opened by electric power), an air conditioner 73, a car stereo 74, an electronic sound source 75, a car navigation system 76, a blinker 77, a remotely-controllable door mirror 78, an adaptive cruise control (ACC) system 79, a steering position change apparatus 80, and an idle reduction system (IS) 81. It should be noted that the above-described apparatuses 71 to 81 are merely examples. All of the apparatuses 71 to 81 may or may not be included in the in-vehicle apparatus 70. The in-vehicle apparatus 70 may include an apparatus other than the above-described apparatuses 71 to 81.

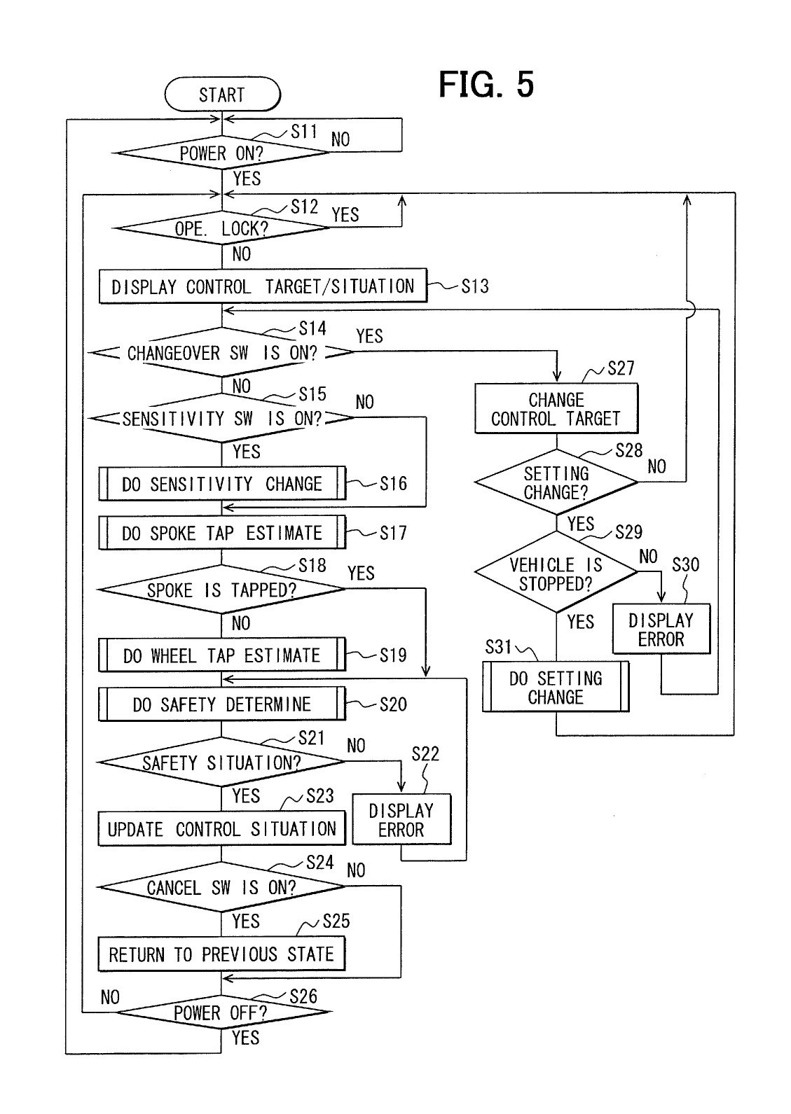

Operation of the information input apparatus 1 for controlling the in-vehicle apparatus 70 will be described. FIG. 5 is a flowchart illustrating a procedure of operation of the information input apparatus 1 for controlling the in-vehicle apparatus 70.

At S11, the controller 40 determines whether or not the electric power is supplied to the information input apparatus 1. When the electric power is not supplied to the information input apparatus 1, corresponding to NO at S11, the controller 40 waits for supply of the electric power. When the electric power is supplied to the information input apparatus 1, corresponding to NO at S11, the procedure proceeds to S12. At S12, the controller 40 determines whether or not an operation by the information input apparatus 1 is prohibited (locked).

When the operation by the information input apparatus 1 is prohibited, corresponding to YES at S12, the controller 40 waits until the operation by the information input apparatus 1 is permitted. When the operation by the information input apparatus 1 is not prohibited, corresponding NO at S12, the procedure proceeds to S13. At S13, the controller 40 outputs a control signal instructing the display 51 to display an in-vehicle apparatus 70 that is presently an operation target. The in-vehicle apparatus 70 serving as the operation target is the in-vehicle apparatus 70 to which the control signal is outputted from the controller 40. Additionally, at S13, from the in-vehicle apparatus 70 serving as the operation target, the controller 40 receives a signal associated with the operational state of the in-vehicle apparatus 70 and outputs a control signal instructing the display 51 to display the operational state. For example, when the in-vehicle apparatus 70 serving as the operation target is the air conditioner 73, the display 51 displays information indicating that the operation target is the air conditioner 73, and information indicative of the operational state of the air conditioner 73.

At S14, the controller 40 determines whether or not the footrest switch 41 is operated (turned on) to input the selection signal, which indicates selection of the content of the operation on the in-vehicle apparatus 70. When the footrest switch 41 is not turned on, corresponding to NO at S14, the procedure proceeds to S15. At S15, the controller 40 determines whether or not the sensitivity switch 42 is operated (turned on) to input a signal instructing a change in the input sensitivity.

When the sensitivity switch 42 is turned on, corresponding to YES at S15, the procedure proceeds to S16. At S16, the controller 40 starts a sensitivity change process. When the sensitivity switch 42 is not turned on, corresponding to NO at S15, the procedure proceeds to S17 while skipping the sensitivity change process at S16. At S17, the controller 40 starts a spoke tapping estimation process.

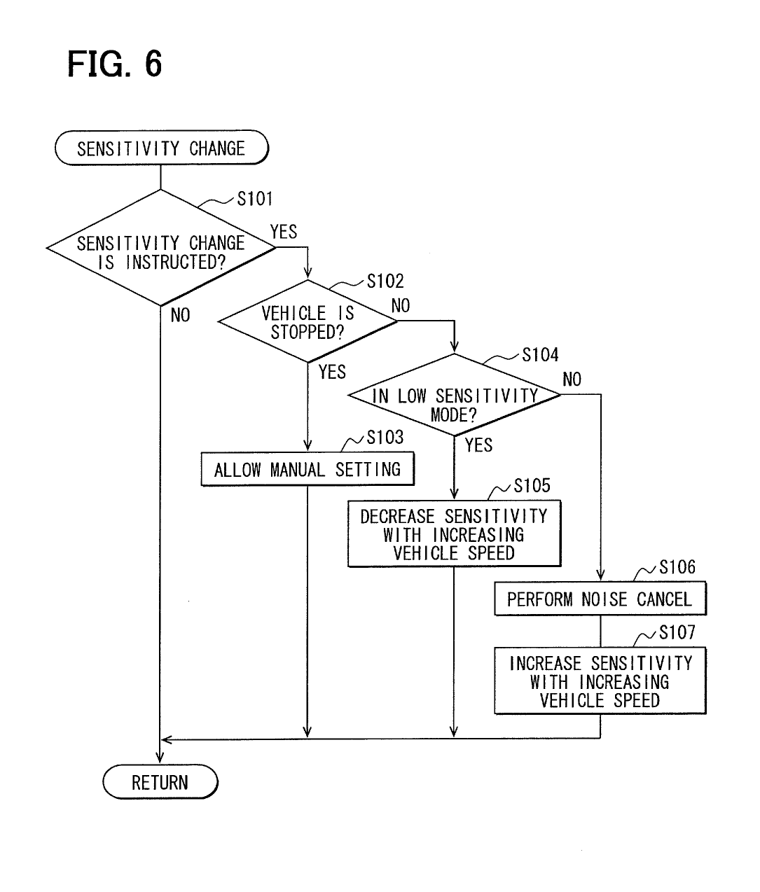

FIG. 6 is a flowchart illustrating content of the sensitivity change process of FIG. 5. Upon starting the sensitivity change process, the controller 40 performs the followings. As shown in FIG. 6, at S101, the controller 40 checks whether or not the signal instructing the sensitivity change is inputted. When the signal instructing the sensitivity change is not inputted, corresponding to NO at S101, the controller 40 ends the sensitivity change process.

When the signal instructing the sensitivity change is inputted, corresponding to YES at S101, the process proceeds to S102. At S102, the controller 40 determines whether or not the vehicle is stopped. This determination is made based on, for example, the speed signal inputted from the vehicle seed sensor 90 via the CAN 44. When the vehicle speed is zero, it is determined that the vehicle is stopped. In this case, the determination YES is made at S102, and the process proceeds to S103. At S103, the controller 40 performs control in the automatic setting mode to enable the driver to manually set the input sensitivity. Upon completion of the setting of the input sensitivity, the procedure proceeds to S17 where the controller 40 starts a spoke tapping estimation process shown in FIG. 5.

When the vehicle speed is not zero, it is determined that the vehicle is not stopped. In this case, the determination NO is made at S102, and the process proceeds to S104. At S104, the controller 40 determines whether or not vibration measurement sensitivity is set to a low sensitivity mode. When the measurement in the low sensitivity mode is performed, the determination YES is made at S104, and the process proceeds to S105. At S105, the controller 40 performs a sensitivity decrease process, in which the vibration measurement sensitivity further decreases in response to an increase in vehicle speed (travel speed).

When the measurement in the low sensitivity mode is not performed, the determination NO is made at S104, and the process proceeds to S106. At S106, the controller 40 performs a noise cancel process. Then, at S107, the controller 40 performs a sensitivity increase process, in which the vibration measurement sensitivity increases in response to the increase in vehicle speed (travel speed). Then, at S17, the controller 40 starts the spoke tapping estimation process, as shown in FIG. 5.

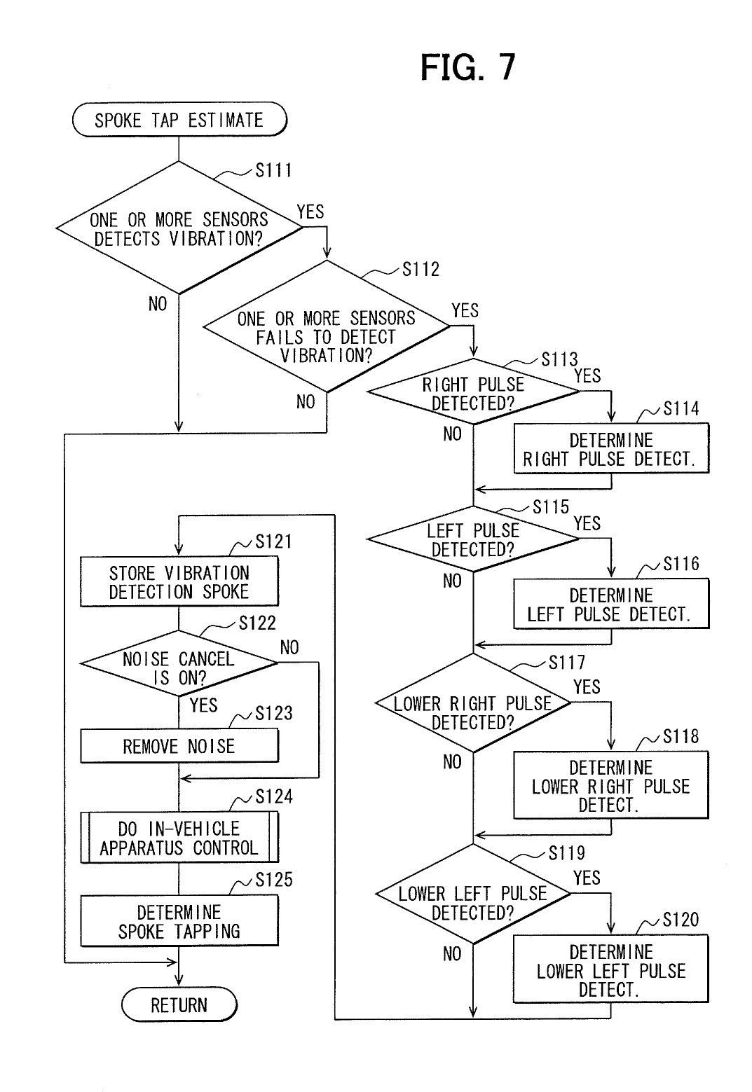

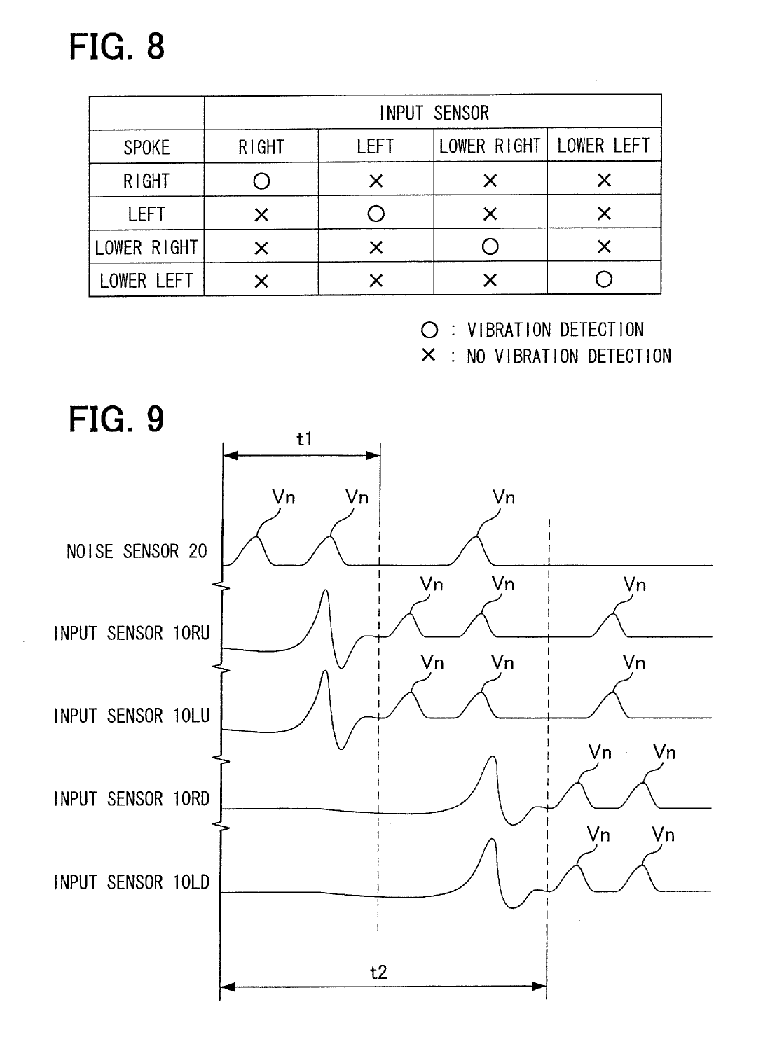

FIG. 7 is a flowchart illustrating the spoke tapping estimation process of FIG. 5. FIG. 8 is a diagram for explanation on the spoke tapping estimation process. As shown in FIG. 7, at S111, when the spoke tapping estimation process is started, the controller 40 determines whether or not the vibration is detected with one or more of the input sensor devices 10RU, 10LU, 10RD, 10LD. When the vibration is not detected with any input sensor device, corresponding to NO at S111, the procedure returns to S18 where the controller 40 checks whether or not the storage device stores information indicating that the spoke 63 is estimated to be tapped by the driver shown in FIG. 5.

When one or more of the input sensor devices detects the vibration, corresponding to YES at S111, the procedure proceeds to S112. At S112, the controller 40 determines whether or not one or more of the input sensor devices 10RU, 10LU, 10RD, 10LD fail to detect the vibration. When the vibration is detected with all of the input sensor devices 10RU, 10LU, 10RD, 10LD, corresponding to NO at S112, the procedure returns to S18 where the controller 40 checks whether or not the storage device stores information indicating that the spoke 63 is estimated to be tapped by the driver shown in FIG. 5.

When one or more of the input sensor devices 10RU, 10LU, 10RD, 10LD fail to detect the vibration, corresponding to YES at S112, the procedure proceeds to S113. At S113, the controller 40 determines whether or not the measurement signal is inputted from the input sensor device 10RU to the controller 40. When the measurement signal is inputted from the input sensor device 10RU, corresponding to YES at S113, the procedure proceeds to S114. At S114, the controller 40 determines that the vibration is detected with the input sensor device 10RU. Additionally, the controller 40 records and stores information in a storage device indicating that the vibration is detected with the input sensor device 10RU.

When the measurement signal is not inputted from the input sensor device 10RU, corresponding to NO at S113, the procedure proceeds to S115. At S115, the controller 40 determines whether the measurement signal is inputted from the input sensor device 10LU to the controller. When the measurement signal is inputted from the input sensor device 10LU, corresponding to YES at S115, the procedure proceeds to S116. At S116, the controller 40 determines that the vibration is detected with the input sensor device 10LU. Additionally, the controller 40 records and stores information in the storage device indicating that the vibration is detected with the input sensor device 10LU.

When the measurement signal is not inputted from the input sensor device 10LU, corresponding to NO at S115, the procedure proceeds to S117. At S117, the controller 40 determines whether or not the measurement signal is inputted from the input sensor device 10RD. When the measurement signal is inputted from the input sensor device 10RD, corresponding to YES at S117, the procedure proceeds to S118. At S118, the controller 40 determines that the vibration is detected with the input sensor device 10RD. Additionally, the controller 40 records and stores information in the storage device indicating that the vibration is detected with the input sensor device 10RD.

When the measurement signal is not inputted from the input sensor device 10RD, corresponding to NO at S117, the procedure proceeds to S119. At S119, the controller 40 determines whether or not the measurement signal is inputted from the input sensor device 10LD. When the measurement signal is inputted from the input sensor device 10LD, corresponding to YES at S119, the procedure proceeds to S120. At S120, the controller 40 determines that the vibration is detected with the input sensor device 10LD. In addition, the controller 40 records and stores information in the storage device, the information indicating that the vibration is detected with the input sensor device 10LD.

At S121, based on the input sensor device(s) with which the vibration is detected, the controller 40 identifies the spoke in which the vibration is detected. Additionally, the controller 40 records and stores the identified spoke 63 in the storage device. At S122, the controller 40 determines whether or not a noise cancel function is running (on) or halted (off). The noise cancel function can be used to remove a noise component contained in the measurement signal, which is outputted from the input sensor device detecting the vibration.

It should be noted that, only in response to the input of the measurement signal indicative of a value larger than a predetermined threshold, the controller 40 determines that the measurement signal is inputted. Because of this, when the value of the measurement signal inputted from the input sensor device 10RU, 10LU, 10RD, 10LD is smaller than the threshold, the controller 40 determines that the measurement signal is not inputted. In this way, even if the input sensor device 10RU, 10LU, 10RD, 10LD measures a weak vibration of the spoke 63 and outputs a measurement signal, the controller 40 determines that the measurement signal is not inputted, as long as the value of the measurement does not exceed the threshold. In the above, the weak vibration may be a vibration other than that generated in response to the driver's tapping of the spoke 63 or the steering wheel 62. The weak vibration includes, for example, a vibration resulting from the run of the vehicle.

When the noise cancel function is in ON, corresponding to YES at S122, the procedure proceeds to S123. At S123, the controller 40 performs a process of removing the noise component from the inputted measurement signal. When the noise cancel function is in OFF, corresponding to NO at S122, the procedure proceeds to S124 without performing the process of removing the noise component from the inputted measurement signal. At S124, the controller 40 starts an in-vehicle apparatus control process.

The process of removing the noise component from the measurement signal may be performed in, for example, the following way. As shown in FIG. 1, the controller 40 retrieves the measurement signal outputted from the noise sensor device 20 mounted to the steering shaft 61. Then, from the measurement signal of the input sensor device 10RU, 10LU, 10RD, 10LD, the controller 40 removes the same component as the measurement signal outputted from the noise sensor device 20. That is, the vibration measured with the noise sensor device 20 is removed from the vibration measured with any one of the input sensor devices 10RU, 10LU, 10RD, 10LD.

FIG. 9 is a graph illustrating a delay time in the process of removing the noise component. In the process of removing the noise component, a difference in noise vibration arrival time between the input sensor devices 10RU, 10LU, 10RD, 10LD is taken into account. The noise vibration is measured with the noise sensor device 20 and then conducted to the input sensor devices 10RU, 10LU, 10RD, 10L. There is a time lag before the noise vibration is measured with the input sensor devices 10RU, 10LU, 10RD, 10L. This time lag is determined by positions of respective input sensor devices 10RU, 10LU, 10RD, 10L and speed of the vibration. Thus, this time lag can be obtained by calculation or can be acquired by previous measurement. The controller 40 performs processing on the measurement signal from the noise sensor device 20 taking into account the time lag. Then, the controller 40 performs the process of removing a signal component from any one of the measurement signals of the input sensor device 10RU, 10LU, 10RD, 10LD. The removed signal component is the same as the measurement signal outputted from the noise sensor device 20.

For example, FIG. 9 illustrates that the vibration acting as noise is conducted from the steering shaft 61 to the spokes 63. Specifically, when the noise vibration Vn is conducting through the steering shaft 61, the noise sensor device 20 detects the noise vibration Vn. This time point is assumed to be a zero time. Then, the noise vibration Vn is conducted to the spoke 63 extending toward the right and/or the spoke 63 extending toward the left, so that the noise vibration Vn is detected with the input sensor device 10RU and/or the input sensor device 10LU. In FIG. 9, it takes a time t1 for the noise vibration to conduct from the noise sensor device 20 to the input sensor device 10RU and/or the input sensor device 10LU. Additionally, the noise vibration Vn is also conducted to the spoke 63 extending toward the lower right and/or the spoke 63 extending toward the lower left, so that the noise vibration Vn is detected with the input sensor device 10RD and/or the input sensor device 10LD. FIG. 9 illustrates an example where a time t2 is taken to conduct the vibration Vn from the noise sensor device 20 to the input sensor device 10LD.

In removing the noise from the measurement signal outputted from the input sensor device 10RU or the input sensor device 10LU, the controller 40 performs a process of delaying the measurement signal outputted from the noise sensor device 20 by a time t1 and removing the noise. In removing the noise from the measurement signal outputted from the input sensor device 10RD or the input sensor device 10LD, the controller 40 performs a process of delaying the measurement signal outputted from the noise sensor device 20 by a time t2 and removing the noise.

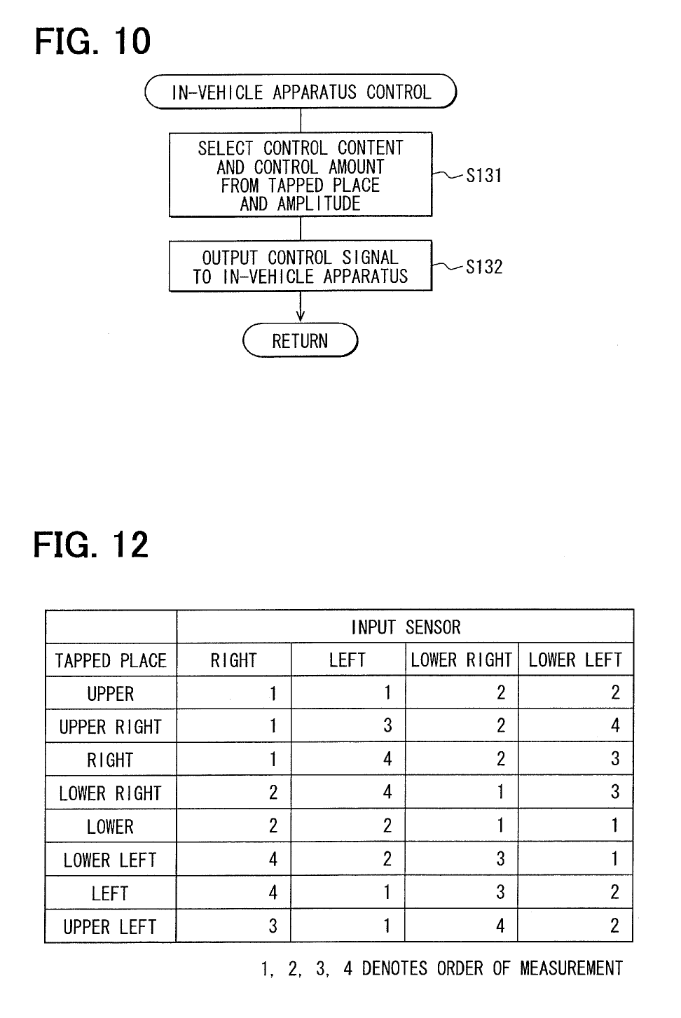

When finishing the noise removing process at S123, the procedure proceeds to S124 where the controller 40 starts the in-vehicle apparatus control process. FIG. 10 is a flowchart illustrating content of the in-vehicle apparatus control process of FIG. 7. As shown in FIG. 10, at S131, based on from which of the input sensor devices 10RU, 10LU, 10RD and 10LD the measurement signal is inputted, the controller 40 determines which of the spokes 63 the driver has tapped. Additionally, the controller 40 determines the amplitude of the measurement signal, and selects control content and a control amount to be outputted to the in-vehicle apparatus 70. A predetermined relationship of the tapped position of the spoke 63 and the amplitude of the measurement signal with the control content and the control amount is stored in the controller 40.

At S132, the controller 40 creates a control signal associated with the selected control content and control amount, and outputs the created control signal to the corresponding in-vehicle apparatus 70. It should be noted that the operation of the in-vehicle apparatus is not started in response to only this control signal. Only after the below-described control signal associated with the start of the operation is inputted, the in-vehicle apparatus 70 performs the control content.

After outputting the control signal at S132, the procedure returns to S125 in FIG. 7. At S125, the controller 40 stores information in the storage device (not shown), the information indicating that it is estimated the driver has tapped the spoke 63. In other words, the controller 40 stores information indicating whether or not one of the input sensor devices 10RU, 10LU, 10RD, 10LD has outputted the measurement signal.

Explanation returns to FIG. 5. At S18, the controller 40 checks whether or not the storage device stores the information indicating that it is estimated the driver has tapped the spoke 63. When the information indicating that the driver has tapped the spoke 63 is not stored in the storage device, corresponding to NO at S18, the procedure proceeds to S19. At S19, the controller 40 starts a steering wheel tap estimation process. When the information indicating that the driver has tapped the spoke 63 is stored in the storage device, corresponding to YES at S18, the procedure proceeds to S2. At S20, the controller 40 starts a safety situation determination process without performing the steering wheel tap estimation process.

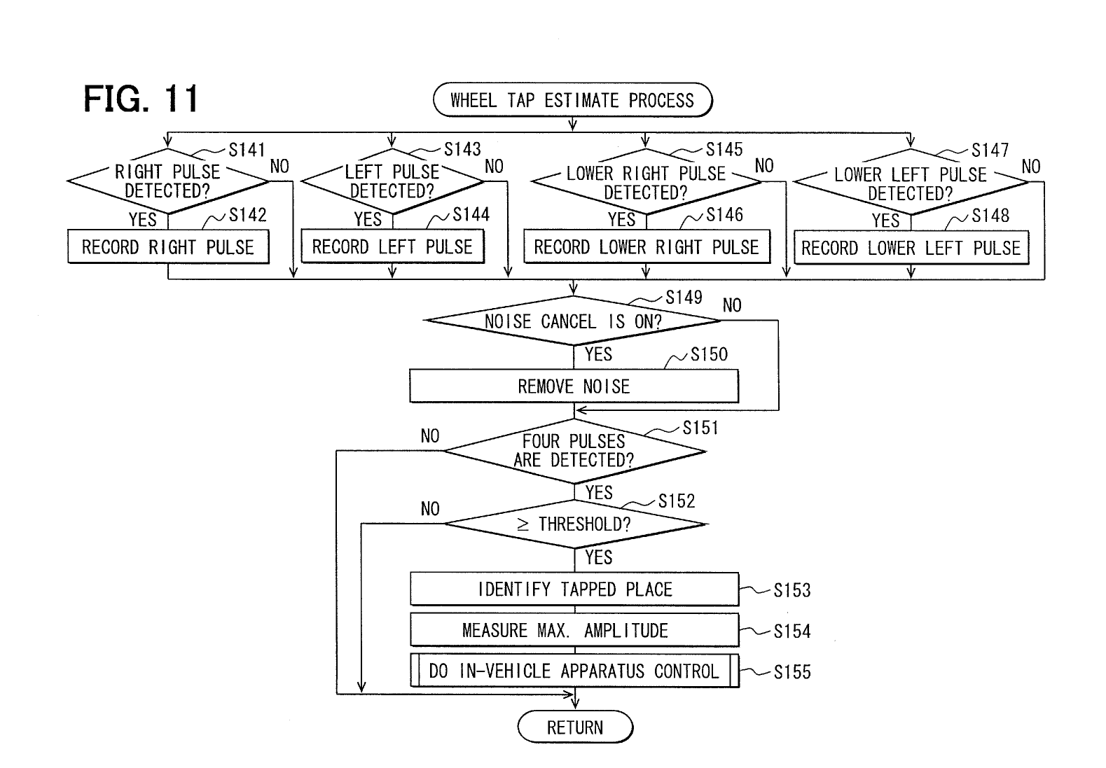

FIG. 11 is a flowchart illustrating content of the steering wheel tap estimation process. Upon starting the steering wheel tap estimation process, the controller 40 performs the following. At S141, the controller 40 determines whether or not the measurement signal is inputted from the input sensor device 10RU. When the measurement signal is inputted from the input sensor device 10RU, corresponding to YES at S141, the process proceeds to S142. At S142, the controller 40 stores the waveform of this measurement signal in the storage device. In the above, storing the measurement signal includes storing a time when the vibration is measured and storing the amplitude of the vibration.

Likewise, at S143, the controller 40 determines whether or not the measurement signal is inputted from the input sensor device 10LU. When the measurement signal is inputted from the input sensor device 10LU, corresponding to YES at S143, the process proceeds to S144. At S144 the controller 40 stores the waveform of this measurement signal in the storage device.

At S145, the controller 40 determines whether or not the measurement signal is inputted from the input sensor device 10RD. When the measurement signal is inputted from the input sensor device 10RD, corresponding to YES at S145, the process proceeds to S146. At S146, the controller 40 stores the waveform of this measurement signal in the storage device.

At S147, the controller 40 determines whether or not the measurement signal is inputted from the input sensor device 10LD. When the measurement signal is inputted from the input sensor device 10LD, corresponding to YES at S147, the process proceeds to S148. At S148, the controller 40 stores the waveform of this measurement signal in the storage device.

When it is determined at each of S141, S143, S145 and S147 that the measurement signal is not inputted, corresponding to NO at each of S141, S143, S145 and S147, the procedure proceeds to S149 without storing the waveform of the measurement signal. At S149, the controller 40 determines whether or not the noise cancel function is running (ON) or halted (OFF).

When the noise cancel function is ON, corresponding to YES at S149, the process proceeds to S150. At S150, the controller 40 performs the process of removing the noise component from the inputted measurement signal. The process of removing the noise component at S150 is substantially the same as that at S116.

When the controller 40 determines that the noise cancel function is OFF, corresponding to NO at S149, the procedure proceeds to S151. At S151, the controller 40 determines whether or not the measurement signals are inputted from all of the input sensor devices 10RU, 10LU, 10RD, 10LD. When the measurement signals are not inputted from all of the input sensor devices 10RU, 10LU, 10RD and 10LD, corresponding to NO at S151, the controller 40 ends the steering wheel tap estimation process.

When the measurement signals are inputted from all of the input sensor devices 10RU, 10LU, 10RD and 10LD, corresponding to YES at S151, the procedure proceeds to S152. At S152, the controller 40 determines whether or not the amplitude of the measurement signal is greater than or equal to a predetermined threshold. When the amplitude of the measurement signal is less than the predetermined threshold, corresponding to NO at S152, the controller 40 ends the steering wheel tap estimation process.

When the amplitude of the measurement signal is greater than or equal to the predetermined threshold, corresponding to YES at S152, the procedure proceeds to S153 by interpreting that there is a tapping from the driver with an intention of input of operation information. At S153, based on the measurement signals from the input sensor devices 10RU, 10LU, 10RD and 10LD, the controller 40 determines an order in which the vibration is detected with the input sensor devices 10RU, 10LU, 10RD and 10LD, and determines which portion of the steering wheel the driver has tapped.

FIG. 12 is a diagram illustrating a relationship between the tapped portion of the steering wheel 62 and the order in which the vibration is measured with the input sensor devices. Specifically, a table like that shown in FIG. 12 is pre-stored in the controller 40. For example, when an upper portion (see also FIG. 2) of the steering wheel 62 is tapped, the vibration is first measured with the input sensor devices 10RU and 10LU, which are on the right portion and the left portion and are at the same distance from the tapped place. Then, the vibration is measured with the input sensor devices 10RD and 10LD, which are on the lower right portion and the lower left portion and are at the same distance from the tapped place. When the upper right portion of the steering wheel 62 is tapped, the vibration is first measured with the input sensor device 10RU, which is on the right portion and closest to the tapped place. Then, in order of distance from the tapped place, the vibration is measured with the input sensor device RD on the lower right portion, the input sensor device LU on the left portion and the input sensors device LD on the lower left portion. As for other portions of the steering wheel 62, in a similar way, the tapped place on the steering wheel can be identified based on the order in which the vibration is measured with the input sensor devices.

After the tapped place of the steering wheel 62 is identified, the procedure proceeds to S154. At S154, the controller 40 measures the maximum value of the amplitude of the measurement signal that has the largest amplitude among the multiple measurement signals. In normal cases, the measurement signal having the largest amplitude is usually outputted from the input sensor device located closest to the tapped place.

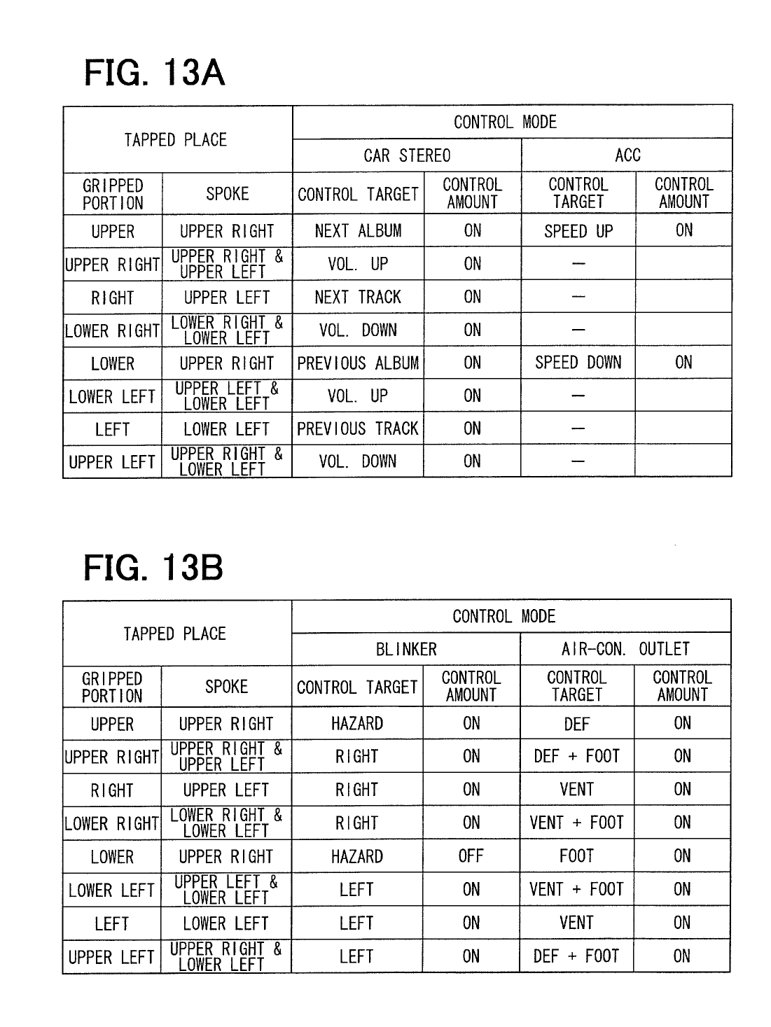

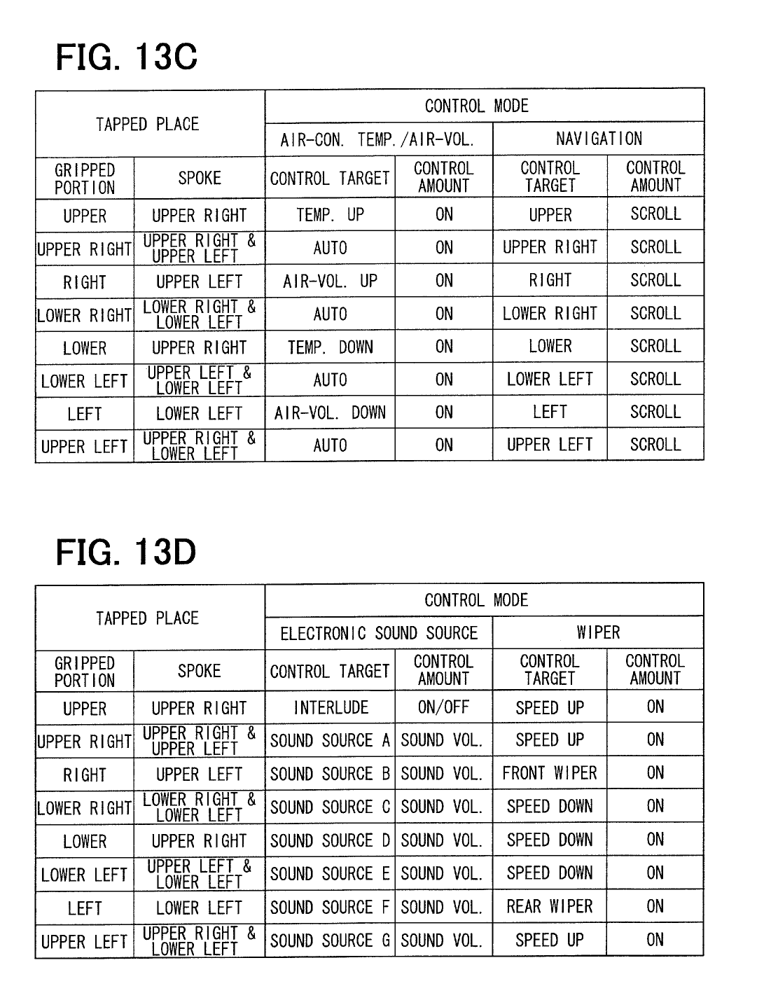

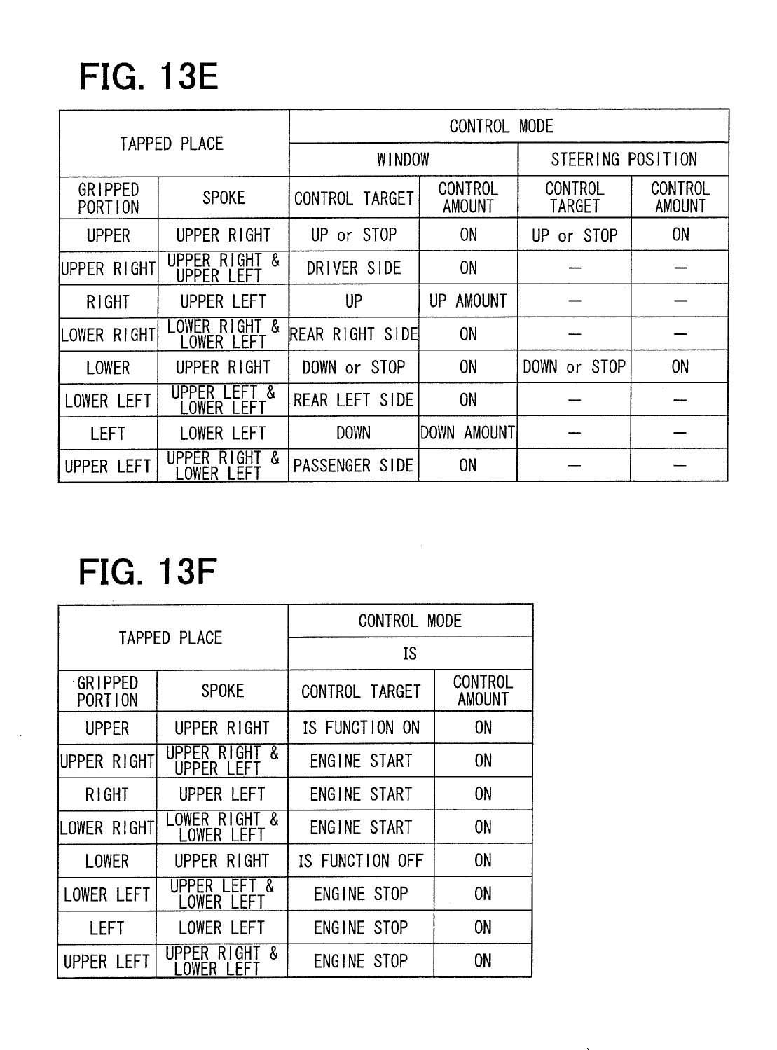

FIGS. 13A to 13F are diagrams illustrating a correspondence among a tapped place of the steering wheel 62 or the spoke 63, a control target, and a control amount. At S155, based on a result of the above-described process, the controller 40 starts the in-vehicle apparatus control process. A table like that shown in FIGS. 13A to 13F is pre-stored in the controller 40. This table is used to determine the correspondence among the tapped place of the steering wheel 62 or the spoke 63, the control target, and the control amount. Based on the tapped place of the steering wheel 62 or the spoke 63 identified at S153, and based on the table like that shown in FIGS. 13A to 13F, the controller 40 selects the control target. Additionally, if the control amount of the selected control target requires designation of a degree other than ON and OFF, the controller 40 determines the control amount in accordance with the maximum value of the amplitude measured at S154.

For example, when the car stereo 74 is controlled, the control target includes album track selection, track change, sound volume change, and the like. The control amount includes placing the control target in operation (on). When the adaptive cruise control (ACC) 79 is controlled, the control target includes a vehicle speed increase (speed up), a vehicle speed decrease (speed down), and the like. The control amount includes placing the control target in operation (on). When the blinker 77 is controlled, the control target includes blinking the blinker indicative of turning right, blinking the blinker indicative of turning left, blinking right and left blinkers at the same time indicative of hazard, and the like. The control amount includes placing the control target in operation (on) and placing the control target in halt (off).

When the air conditioner 73 is controlled, the control target includes a change in outlet for conditioned-air, a change in volume of blown-air, and the like. The control amount includes placing the control target in operation (on). When the navigation system 76 is controlled, the control target includes designation of direction (upper direction, lower direction, right direction, left direction etc.) in which an image (e.g., map image) is scrolled. The control amount includes placing the control target in operation (scrolling).

When the electronic sound source 75 is controlled, the control target includes synchronization tapping (see JP-2011-186622A), each sound source (e.g., sound source A, sound source B, . . . , sound source G), and the like. The control amount includes turning on the synchronization tapping, turning off the synchronization tapping, and a sound volume of each sound source. The sound volume is controlled based on magnitude of tapping of the steering wheel 62, in other words, based on the magnitude of the vibration measured with each sensor device. When the wiper 71 is controlled, the control target includes front wiper selection, rear wiper selection, wiper movement speed increase (speed up), wiper movement speed decrease (speed down), and the like. The control amount includes placing the control target in operation (on).

When the window 72 is controlled, the control target includes designation of controlled window place (a driver side window, a front passer side window etc.), window rising and lowering (UP and DOWN), and the like. The control amount includes placing the control target in operation (ON). An amount of rising and lowering the window may be determined based on the magnitude of tapping of the steering wheel 62 or the spoke 63, in other words, based on the magnitude of the amplitude of the vibration measured with each sensor device.

When the steering position change apparatus 80 is controlled, the control target includes rising (up) and lowering (down) position of the steering device 60. The control amount includes placing the control target in operation (ON). When the idle reduction system (IS) 81 is controlled, the control target includes execution and halt of the idle reduction function, start up and stop of the engine, and the like. The control amount includes placing the control target in operation.

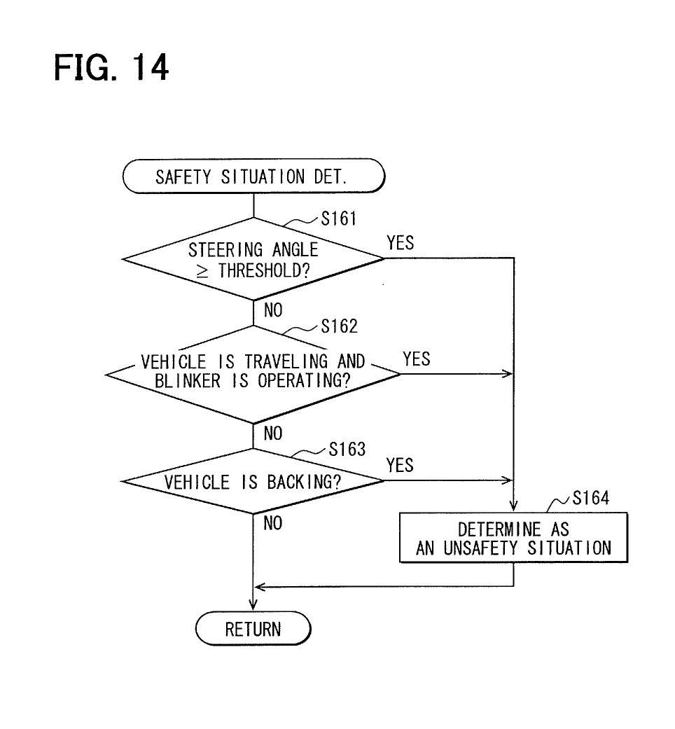

FIG. 14 is a flowchart illustrating content of the safety situation determination process. After ending the in-vehicle apparatus control process at S19, the controller 40 starts the safety situation determination process at S20, as shown in FIG. 5. As shown in FIG. 14, at S161, the controller 40 determines whether or not the steering angle is greater than or equal to a threshold. For example, the controller 40 receives a measurement signal from a sensor that measures a rotation phase of the steering shaft 61. The controller 40 compares value of the measurement signal with a pre-stored threshold. Since this measurement signal correlates with the steering angle indicative of the steering wheel's direction, the controller 40 can compare the threshold with the value of the measurement signal to determine whether or not the steering angle is greater than or equal to the predetermined threshold (e.g., 45 degrees).

When the controller 40 determines that the steering angle is less than the predetermined threshold, corresponding to NO at S161, the procedure proceeds to S162. At S162, the controller 40 determines whether or not the vehicle is traveling (e.g., moving forward) and the blinker 77 is in operation. For example, based on the speed signal outputted from the vehicle seed sensor 90, the controller 40 determines whether or not the vehicle is traveling. Additionally by checking a history of the control signal outputted to the blinker 77, the controller 40 determines whether the blinker 77 is in operation.

When the vehicle is not traveling and the blinker 77 is not in operation, corresponding to NO at S162, the procedure proceeds to S163. At S163, the controller 40 determines whether or not the vehicle is backing (moving backward). For example, based on the speed signal outputted from the vehicle seed sensor 90, the controller 40 determines whether or not the vehicle is backing. When the vehicle is not backing, corresponding to NO at S163, the controller 40 ends the safety situation determination process, and the procedure returns to S21 in FIG. 5. At S21, the controller 40 determines whether or not the vehicle is in a safety situation.

When it is determined at S161 that the steering angle is greater than or equal to the predetermined threshold (YES at S161), or when it is determined at S162 that the vehicle is traveling and the blinker 77 is in operation (YES at S162), or when it is determined at S163 that the vehicle is backing (YES at S163), the procedure proceeds to S164. At S164, the controller 40 determines that, from viewpoint of inputting the operation information, the vehicle is not a safety situation. Further, the controller 40 stores a result of this determination in the storage device.

After S164, the controller 40 ends the safety situation determination process, and the procedure returns to S21 in FIG. 5 to determine whether or not the vehicle is in a safety situation. Specifically, the controller 40 checks whether or not the storage device stores the result of the determination at S164 indicating that the vehicle is not in the safety situation. When the storage device stores the result of the determination indicating that the vehicle is not in the safety situation, corresponding to NO at S21, the procedure proceeds to S22. At S22, the controller 40 outputs a control signal to the display 51 instructing error display, and then, the procedure returns to S20 so that the safety situation determination is repeated.

When the result of the determination indicating that the vehicle is not in the safety situation is not stored in the storage device, in other others, when the result of the determination indicating that the vehicle is in the safety situation is stored in the storage device, the determination YES is made at S22. In this case, the procedure proceeds to S23 where the controller 40 updates a control situation. Specifically, based on the already-outputted control signal, the controller 40 outputs a control signal instructing the start of the operation of the in-vehicle apparatus 70.

Then, at S24, the controller 40 determines whether or not the cancel switch 43 is operated. Specifically, in response to the update of the control situation at S23, the in-vehicle apparatus 70 starts the operation based on the inputted operation information. At S24, it is determined whether or not there is an input of the operation information instructing cancelation of the operation that the in-vehicle apparatus 70 has started.

For example, when the driver presses down the cancel switch 43 to input the operation information instructing the cancellation of the operation, a signal associated with the cancellation is inputted from the cancel switch 43 to the controller 40 (YES at S24). At S25, the controller 40 instructs the in-vehicle apparatus 70, which started the operation, to stop the operation and return to a state just before the in-vehicle apparatus 70 started the operation.

Because of this, if an erroneous input of the operation information causes the in-vehicle apparatus 70 to starts a driver unintentional operation, it is possible to easily cancel the operation, and it is possible to returns the in-vehicle apparatus 70 to a previous state, which is a state before the wrong input. In particular, by performing a single manipulation of the cancelation switch 43, the driver can perform two operations which are the cancellation of the operation and the return back to the previous state. It is possible to reduce the driver's manipulation burden.

After the control signal is outputted at S25, the procedure proceeds to S26. At S26, the controller 40 determines whether or not the information input apparatus 1 is powered off. When the cancel switch 43 is not operated, corresponding to NO at S24, the process proceeds also to S26 where the controller 40 determines whether or not the information input apparatus 1 is powered off. For example, if there is no operation of the cancel switch 43 for a predetermined period time after the update of the control situation at S23, the controller 40 determines that the cancelation switch 43 is not operated.

Whet the information input apparatus 1 is powered off, corresponding to YES at S26, the procedure returns to S11. When the information input apparatus 1 is not powered off, corresponding to NO at S26, the procedure returns to S12 to repeat the above-described processes. In this case, at S13, the display 51 displays the updated operation situation of the in-vehicle apparatus 70. In this way, a result of input of the operation information is fed back to the driver.

The feedback as to the result of input may be given to the driver with use of the auditory sense stimulator 53, the tactile sense stimulator 54, and/or the visual sense stimulator 52, in addition or in place of display of the operation situation on the display 51.

For example, if the auditory sense stimulator 53 includes a speaker embedded in each of the upper, lower, right, left, upper right, lower right, upper left, and lower left portions of the steering wheel 62, the speaker embedded in the portion estimated to be tapped by the driver may generate a sound as a feedback to the driver as to the result of input. The auditory sense stimulator 53 may include the speakers. However, the auditory sense stimulator 53 is not limited to the speakers and may include other device that stimulates auditory sense.

If the tactile sense stimulator 54 includes a vibration generator embedded in each of the upper, lower, right, left, upper right, lower right, upper left, and lower left portions of the steering wheel 62, the vibration generator embedded in the portion estimated to be tapped by the driver may vibrate to give feedback to the driver as to the result of input. The tactile sense stimulator 54 may include the vibration generators. However, the tactile sense stimulator 54 is not limited to the vibration generator, and may include other device that stimulates tactile sense.

When the visual sense stimulator 52 includes a light emitter embedded in each of the upper, lower, right, left, upper right, lower right, upper left, and lower left portions of the steering wheel 62, the light emitter embedded in the portion estimated to be tapped by the driver may light up to give feedback to the driver as to the result of input. The visual sense stimulator 52 may include the light emitters. However, the visual sense stimulator 54 is not limited to the light emitters, and may include other device that stimulates tactile sense.

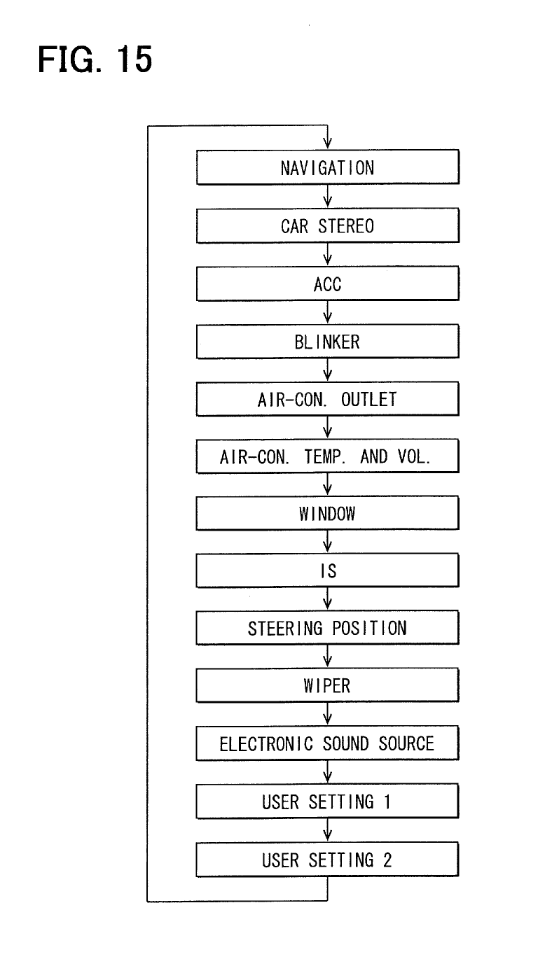

FIG. 15 is a diagram illustrating switching between the in-vehicle apparatuses in the control target switch process. When it is determined at S14 that the footrest switch 41 is operated, corresponding to YES at S14, the procedure proceeds to S27. At S27, the controller 40 starts the control target switch process. For example, when the spoke 63 extending to the left is tapped by the driver, the measurement signal indicating that the spoke 63 is tapped is inputted from the input sensor device LU to the controller 40. In this case, as shown in FIG. 15, every time the control signal is inputted, the controller 40 changes the in-vehicle apparatus, which is a target of control, from one to another. FIG. 15 shows an example where the target of control is changed from one in-vehicle apparatus 70 to another in-vehicle apparatus 70 in an order from top to bottom in the drawing sheet of FIG. 15. In FIG. 15, there are a first user setting and a second user setting, in each of which a user can set control targets. In the above, the footrest switch 41 is an example of a selector for receiving selection information from the driver.

When the in-vehicle apparatus 70 serving as the control target is switched, the controller 40 determines whether the setting of the in-vehicle apparatus 70 serving as the control target is to be changed. For example, the controller 40 determines whether or not the spoke 63 extending to the right is tapped by the driver. When it is determined that the setting is not to be changed, corresponding to NO at S28, the procedure returns to S12 to repeat the above-described processes.

When it is determined that the setting is to be changed, corresponding to YES at S28, the procedure returns to S29. At S29, the controller 40 determines whether or not the vehicle is stopped. For example, based on the measurement signal outputted from the vehicle seed sensor 90, the controller 40 determines whether or not the vehicle is stopped or is traveling. When it is determined that the vehicle is traveling, corresponding to NO at S29, the procedure proceeds to S30. At S30, the controller 40 outputs a control signal to the display 51 instructing the display 51 to display an error massage. After S30, the procedure returns to S14 to repeat the above-described processes.

When it is determined that the vehicle is stopped, corresponding to YES at S29, the procedure proceeds to S31. At S31, the controller 40 performs a setting change process. In the setting change process, the assigned control targets are changed. The assigned control targets are control targets assigned to respective portions of the steering wheel 62, e.g., the upper portion, the lower portion, the right portion, the left portion, the upper right portion, the lower right portion, the upper left, and the lower left portion of the steering wheel 62.

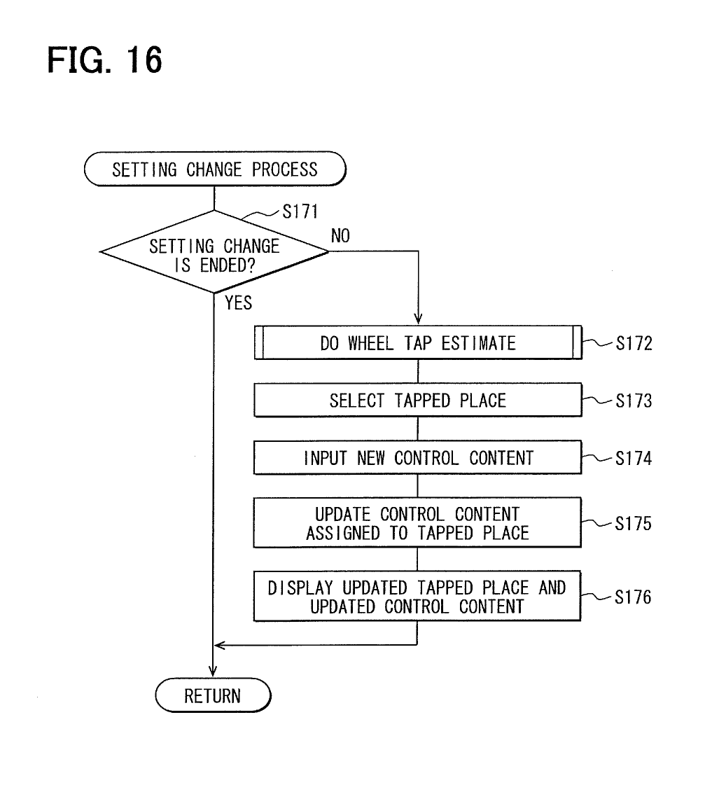

FIG. 16 is a flowchart illustrating content of the setting change process. As shown in FIG. 16, at S171, the controller 40 determines whether or not a change in the setting is to be ended. When information instructing an end of the change in the setting is inputted, corresponding to YES at S171, the controller 40 ends the setting change process, and the procedure returns to S12 in FIG. 5.

When the change in the setting is not to be ended, corresponding to NO at S171, the procedure proceeds to S172. At S172, the controller 40 starts a wheel tap estimation process to estimate which of the portions of the steering wheel 62 the driver has tapped. The above wheel tap estimation process is substantially the same as processes S141 to S153 in the steering wheel tap estimation process at S19. Thus, explanation on the wheel tap estimation process is omitted here.

When the tapped place, which is the tapped portion of the steering wheel 62, is estimated, the controller 40 outputs a control signal (command) instructing the display 51 to display the estimated tapped place, thereby asking the driver for confirmation. When the driver judges that the tapped place displayed on the display 51 is correct, the controller 40 receives, at S173, the operation information indicating a selection of the tapped place.

At S174, the controller 40 receives information indicative of the control content newly assigned to the selected tapped place. For example, the driver presses a switch for selecting a function (i.e., the control content) of the in-vehicle apparatus 70 serving as the target, thereby inputting the newly-assigned control content.

When the newly-assigned control content is inputted, the procedure proceeds to S175. At S175, the controller 40 assigns the inputted new control content to the selected tapped place, and updates content of the table determining the correspondence between the tapped places and the control contents. At S176, the controller 40 outputs a control signal instructing the display 51 to display the updated tapped place and control content. After S177, the procedure returns to S12 in FIG. 5, and the above-described processes are repeated.

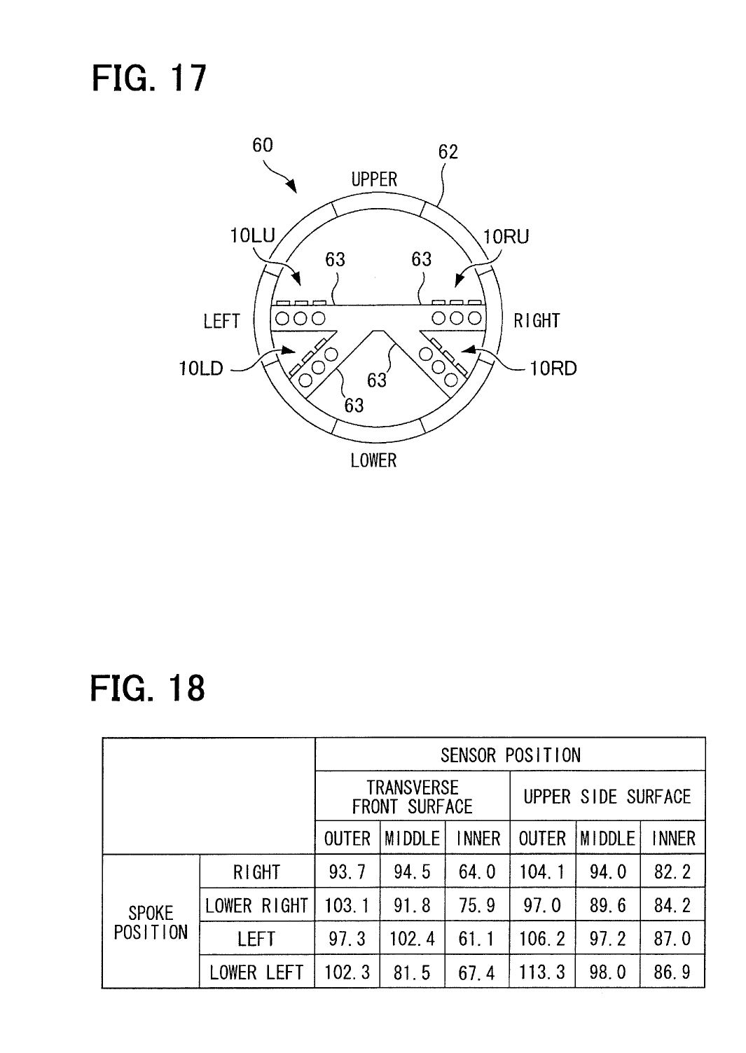

FIG. 17 is a diagram for explanation on an experiment about arrangement positions of the input sensor devices 10. FIG. 18 is a diagram illustrating voltages of measurement signals outputted from the input sensor devices 10RU, 10LU, LORD, 10LD arranged at the positions shown in FIG. 17.

When the input sensor device 10RU, 10LU, 10RD, 10LD is arranged at a radially-outer portion of an upper side surface of the spoke 63, vibration measurement is facilitated. This will be explained. In an example shown in FIG. 17, each of the input sensor devices 10RU, 10W, 10RD, 10LD includes a first group of sensor elements arranged on a lateral front surface of the spoke 63 and a second group of sensor elements arranged on an upper side surface of the spoke 63. Specifically, each of the first group and the second group includes three sensor elements, which are arranged at a radially-outer place, a radially-middle place, and a radially-inner place of the spoke 63, respectively. The radially-outer place is located in the vicinity of the steering wheel 62. The radially-middle place is between the radially-outer place and the radially-inner place. In the present disclosure, the lateral front surface of the spoke 63 refers to a surface arranged to face the driver. In FIG. 17, the lateral front surface of the spoke 63 is arranged to be parallel to the sheet. The upper side surface of the spoke 63 refers to a surface on an upper side of the spoke 63. In FIG. 17, the upper side surface of the spoke 63 faces in an upper direction.

In the experiment, a peak to peak (Pk-Pk) value of voltage of the measurement signal outputted from the input sensor device 10RU, 10LU, 10RD,10LD when each of the upper, lower, right and left portions of the steering wheel 62 was tapped with a finger was measured. The number of measurements for tapping of each of the upper, lower, right and left portions of the steering wheel 62 is 360 times. A measurement result is an average of the values obtained from all of the measurements (see FIG. 18).

A result of the experiment shown in FIG. 18 shows that the sensor element of the input sensor device 10 arranged at the radially outer place of the upper side surface outputs the measurement signal with a largest Pk-Pk value. It is shown that, as compared with other place, the radially outer place (i.e., a place close to the steering wheel 62) of the upper side surface is an appropriate place for vibration measurement.

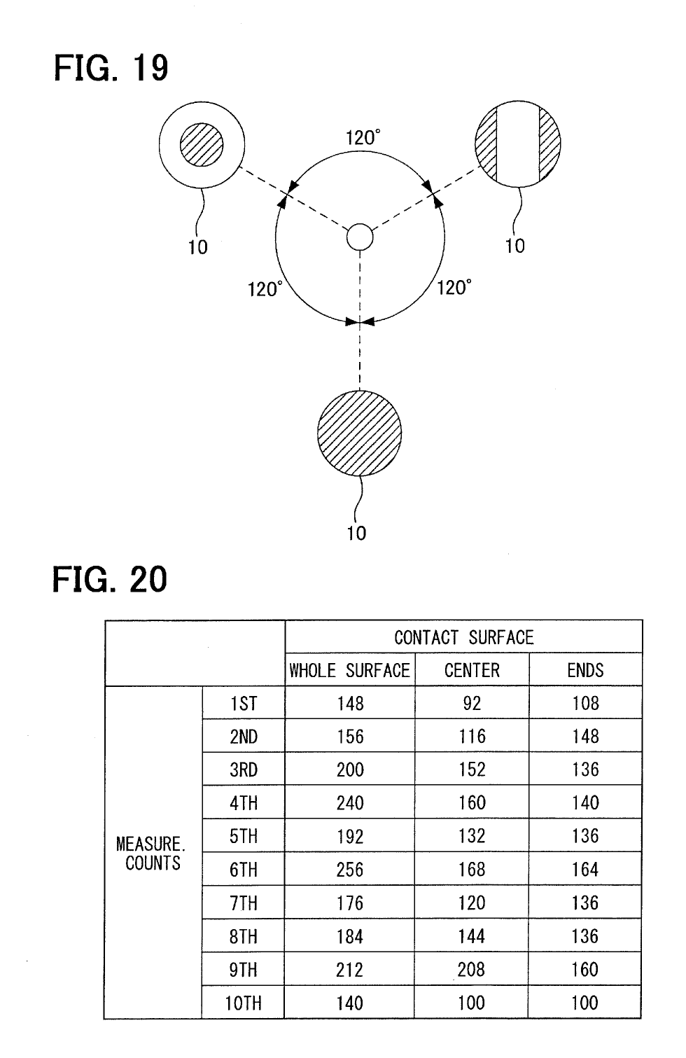

FIG. 19 is a diagram for explanation on an experiment about a contact surface between the input sensor device 10 and the spoke 63. FIG. 20 is a diagram for explanation on voltage of the measurement signal outputted from the input sensor device 10 shown in FIG. 19.

Next, explanation will be given on facilitating the vibration measurement by bringing a whole surface of the input sensor device 10 into contact with the spoke 63. In FIG. 19, three input sensor devices 10 are on an aluminum plate so that the three input sensor devices 10 are arranged on a same circle at regular intervals (120 degrees). A contact surface between the input sensor device 10 and the aluminum plate is shown by a hatched portion in FIG. 19. One input sensor device 10 contacts the aluminum plate in such a way that a whole surface of the input sensor device 10 is in contact with the aluminum plate. Another input sensor device 10 contacts the aluminum plate in such a way that a center region of the e input sensor device 10 is in contact with the aluminum plate. The other input sensor device 10 contacts the aluminum plate in such a way that an opposite end regions of the input sensor device 10 is in contact with the aluminum plate.

In the experiment, a center of the circle along which the input sensor devices 10 are arranged was tapped, and a generated vibration was detected with the input sensor devices 10. A Pk-Pk value of voltage of a measurement signal outputted from each input sensor device 10 was measured. FIG. 20 shows that, in every measurement, the input sensor device 10 having the whole surface being in contact with the aluminum plate outputs the measurement signal with a largest Pk-Pk value. That is, the input sensor device 10 having the whole surface being in contact with the aluminum plate can easily measure the vibration, as compared with the input sensor device 10 which partly contacts the aluminum plate.

According to the above configuration, the input sensor devices 10RU, 10LU, 10RD, 10LD are in close contact with the surface of the framework of the spoke 63. Thus, as compared with a case where a sensor is embedded inside the steering wheel 62, the present embodiment facilitates arranging the input sensor devices 10RU, 10LU, 10RD, 10LD. Moreover, in the present embodiment, the input sensor devices 10RU, 10LU, 10RD, 10LD can be mounted without a change in configuration of the steering wheel 62 or the spoke 63, or with a relatively small change in the configuration of the steering wheel 62 or the spoke 63, as compared with the case where the sensors are embedded in the steering wheel 62.

Even when the driver applies a load to the steering wheel 62 or the spoke 63 in turning the steering wheel 62, the controller 40 does not output the control signal to the in-vehicle apparatus 70 unless the spoke 63 vibrates. In other words, according to the present embodiment, it is possible to prevent the information input apparatus 1 from erroneously recognizing the steering of the vehicle as the input of the operation information and from outputting an erroneous control signal to the in-vehicle apparatus 70.

In the present embodiment, the vibration is measured with the input sensor devices 10RU, 10LU, 10RD, 10LD, which are arranged at multiple places. Therefore, before being measured, the vibration travels a shorter distance as compared with a case where a single sensor at a single place measures the vibration propagating through the steering wheel in a clockwise direction and an anticlockwise direction. Therefore, in the present embodiment, the input sensor devices 10RU, 10LU, 10RD, 10LD cam measure the vibration with a large amplitude. The operation information following the driver's intention can be easily indentified.

In the present embodiment, the operation information reflecting the driver's intention is indentified based on a vibration measurement order, which is an order in which the vibration is measured with the input sensor devices 10RU, 10LU, 10RD, 10LD. Therefore, even when the measured vibration contains noise such as vehicle vibration and the like, the operation information reflecting the driver's intention can be easily indentified.

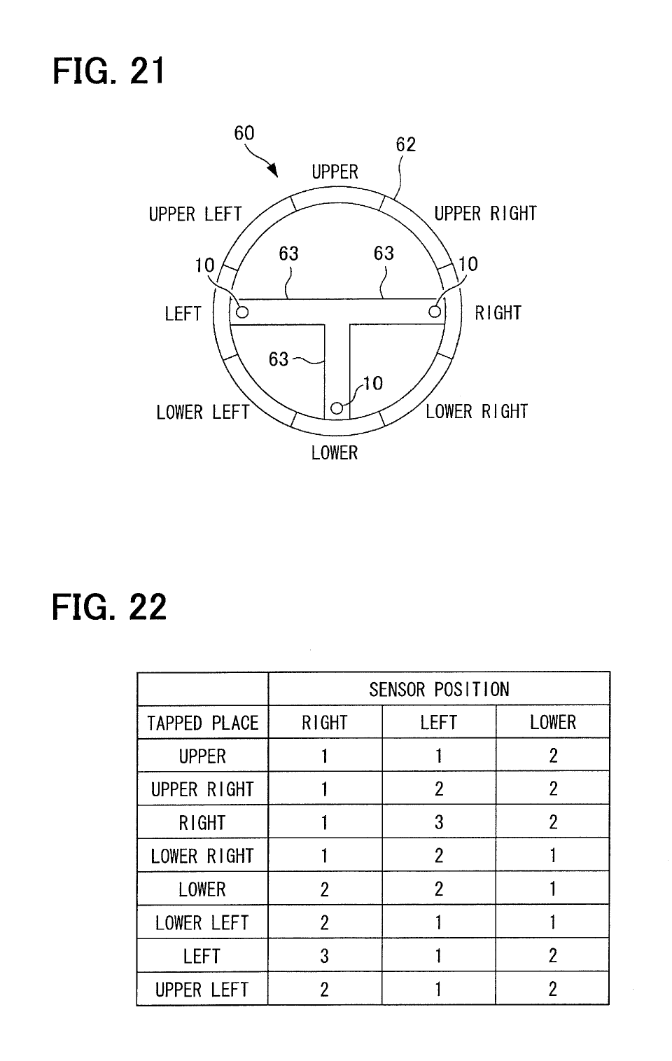

FIG. 21 is a diagram illustrating a steering device 60 of another embodiment. FIG. 22 is a diagram illustrating a relationship between a tapped place of the steering device 60 of FIG. 21 and a vibration measurement order in which the vibration is measured with the multiple input sensor devices 10.

The steering device 60 may have four spokes 63 as described in FIG. 1. Alternatively, as shown in FIG. 21, the steering device 60 may have three spokes 63, which are arranged into, but not limited to, a T shape. If the steering device 60 has a configuration shown in FIG. 21, it is possible to make a determination of which of the upper, upper right, right, lower right, lower, lower left, left, and upper left portions the tapped portion is (see FIG. 22), in a manner similar to that in the steering device 60 having the four spokes 63.

The input sensor device 10RU, 10LU, 10RD, 10LD may include a piezoelectric element, as described above. However, an element of the input sensor device 10RU, 10LU, 10RD, 10LD may not be limited. For example, an acceleration sensor for measuring an acceleration caused by vibration of the spoke 63 may be employed. As this acceleration sensor, an acceleration sensor for measuring an acceleration change in one direction may be used. Alternatively, an acceleration sensor or measuring acceleration changes in two directions perpendicular to each other may be used for the input sensor device 10RU, 10LU, 10RD, 10LD. In this configuration, it is possible to identify not only a tapping in one direction but also a tapping in two perpendicular directions. Thus, it is possible to output a control signal associated with a double amount of the operation information to the in-vehicle apparatus 70, as compared with a case of the above-described embodiment.

A surface of the steering wheel 62 may be covered with a same material as a whole. Alternatively, the upper, upper right, right, lower right, lower, lower left, left, upper left portions of the steering wheel 62 may be covered with different materials so as to be visually or tactually distinguishable.

### Second Embodiment

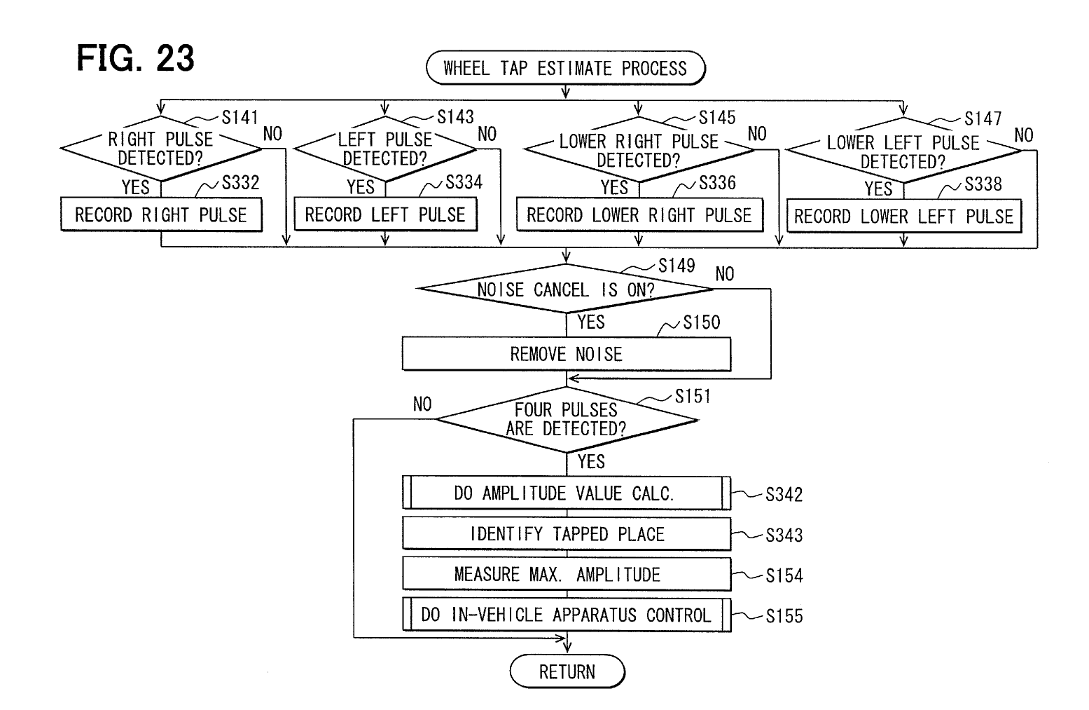

A second embodiment will be described below with reference to FIGS. 23 to 27. A basic configuration of an information input apparatus of the present embodiment is similar to that of the first embodiment. The present embodiment is different from the first embodiment in content of the wheel tap estimation process. In the following, content of the wheel tap estimation process will be explained with use of FIGS. 23 to 27. Explanation on other configurations may be omitted.

FIG. 23 is a flowchart illustrating content of the wheel tap estimation process of the present embodiment. In the present embodiment, upon starting the wheel tap estimation process, the controller 40 performs the following. As shown in FIG. 23, at S141, the controller 40 determines whether or not the measurement signal is inputted from the input sensor device RU. When the measurement signal is inputted from the input sensor device RU, corresponding to YES at S141, the procedure proceeds to S332. At S332, the controller 40 stores in a storage device (not shown) waveform of the measurement signal and in particular amplitude of the measurement signal.

Likewise, at S143, S145 and S147, the controller determines whether or not the measurement signal is inputted from the input sensor device 10LU, 10RD, 10LD. When the measurement signal is inputted from the input sensor device 10LU, 10RD, 10LD (corresponding to YES), the controller 40 stores in the storage device the amplitude of the measurement signal (S334, S336, S338).

When it is determined at S141, S143, S145, S147 that the measurement signal is not inputted (corresponding to NO), the procedure proceeds to S149 without storing the amplitude of the measurement signal. At S149, the controller 40 determines whether the noise cancel function is running (ON) or halted (OFF).

When the noise cancel function is ON, corresponding to YES at S149, the procedure proceeds to S150. At S150, the controller 40 performs a process of removing a noise component from the inputted measurement signal. The process of removing the noise component at S150 is substantially the same as that at S116. Thus, explanation on S150 is omitted.

When it is determined that the noise cancel function is OFF, corresponding to NO at S149, the process proceeds to S151. At S151, the controller 40 determines whether or not the measurement signals are inputted from all of the input sensor devices 10RU, 10LU, 10RD, 10LD. When the measurement signals are not inputted from all of the input sensor devices 10RU, 10LU, corresponding to NO at S151, the controller 40 ends the wheel tap estimation process.

At S151, when the measurement signals are inputted from all of the input sensor devices 10RU, 10LU, 10RD, 10LD, corresponding to YES at S151, the procedure proceeds to S342 where the controller 40 performs an amplitude calculation process.

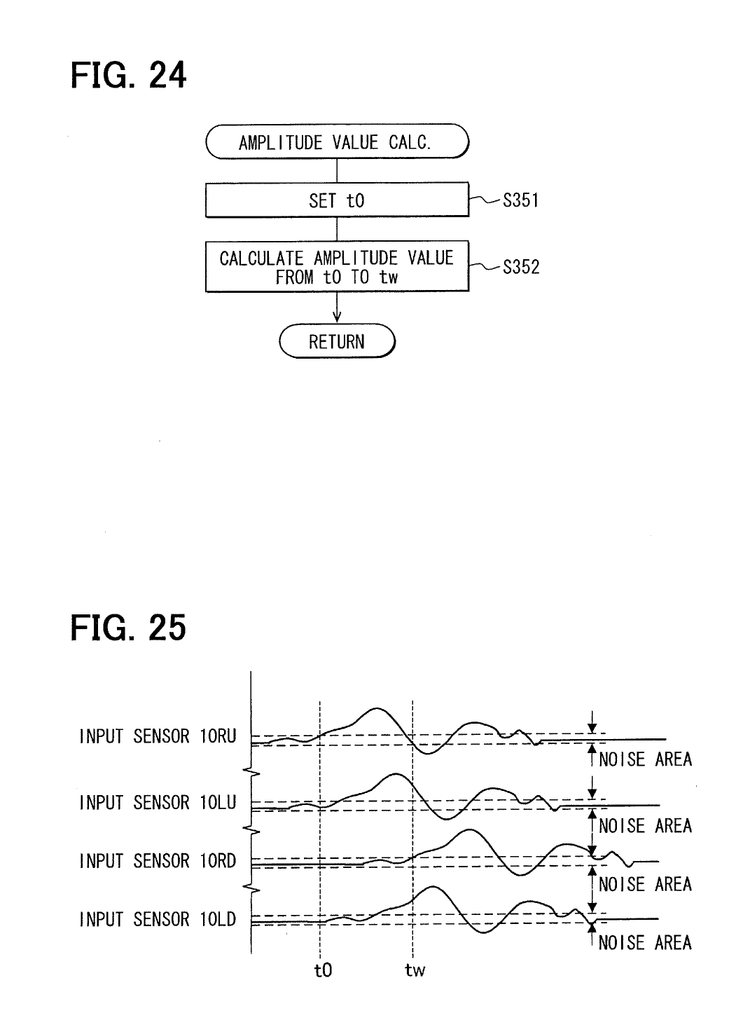

FIG. 24 is a flowchart illustrating content of the amplitude calculation process. FIG. 25 is a graph for explanation on the content of the amplitude calculation process. Upon starting the amplitude calculation process, at S351, the controller 40 sets a time t0, as shown in FIGS. 24 and 25. The time t0 is a time when amplitude of any one of the input sensor devices 10RU, 10RD, 10LU, 10LD exceeds a noise area (threshold). In an example shown in FIG. 25, the time t0 is set to a time when the amplitude of the measurement signal outputted from the input sensor device 10RU exceeds the noise area.

At S352, the controller 40 calculates an amplitude value from the time t0 to a time tw. The amplitude value to be calculated may be, for example, a value of integral of the amplitude value from the time t0 to the time tw, a maximum value or a Pk-Pk value of the amplitude value during a period from the time t0 to the time tw, or the like.

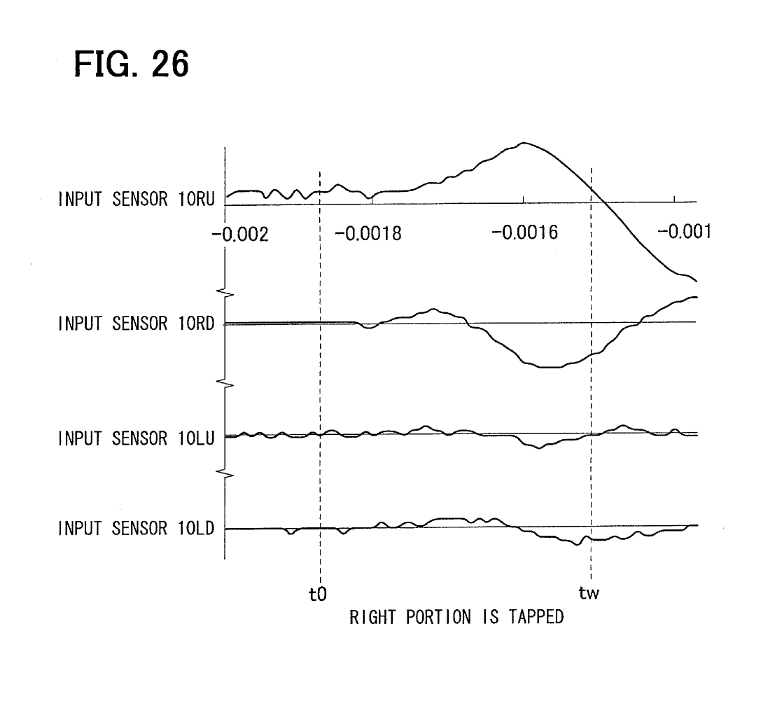

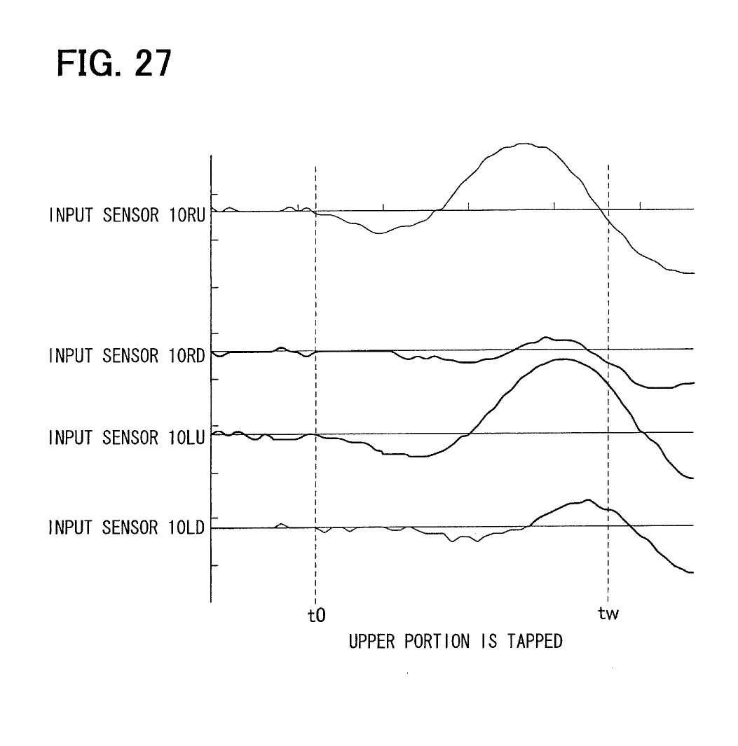

FIGS. 26 and 27 are graphs for explanation on calculation of the amplitude value of FIG. 24. FIG. 26 is directed to a case where the right portion of the steering wheel 62 is tapped. FIG. 27 is directed to a case where the upper portion of the steering wheel 62 is tapped.

For example, the value of integral of the amplitude value from the time t0 to the time tw may be used as the amplitude value. This example will be specifically described with reference to FIGS. 26 and 27. As shown in FIG. 26, when the right portion of the steering wheel 62 is tapped, the measurement signal outputted from the input sensor 10RU has the largest amplitude variation. The measurement signal outputted from the input sensor 10RD has the second largest amplitude variation. Both of the measurement signals outputted from the input sensor devices 10LU, 10LD have a small amplitude change. The measurement signal from the input sensor device 10RU gives the largest value of integral of the amplitude value from the time t0 to the time tw. The measurement signal from the input sensor device 10RD gives the second largest value of integral. The value of integral becomes smaller in an order of the input sensor devices 10RD and 10LU.

When the upper portion of the steering wheel 62 is tapped, the measurement signals outputted from the input sensor devices 10RU, 10LU have the largest amplitude variation. Then, the measurement signals outputted from the input sensor devices 10RD, 10LD have a smaller amplitude variation. The measurement signals from the input sensor devices 10RU, 10LU give the largest value of integral of the amplitude value from the time t0 to the time tw. The measurement signals from the input sensor device 10RD, 10LD give a smaller value of integral.

Then, the proceeding returns to S343 in the flowchart of FIG. 23. At S343, based on an order of the calculated amplitude of the measurement signals, the controller 40 identifies the tapped place of the steering wheel 62. Since the tapped place can be identified based on the pre-stored table describing a relationship between the tapped place and the order of amplitude in a manner similar to that at S153, explanation on S343 is omitted. Since processes after identification of the tapped place can be similar to those in the first embodiment, explanation is omitted.

In the above embodiments and drawings, the reference numeral 1 denotes the information input apparatus. The reference numerals 10, 10RU, 10RD, 10LU, 10LD denote the input sensor device, which can correspond to a measurement device. The reference numeral 40 denotes the controller. The reference numeral 41 denotes the footrest switch 41, which can correspond to a selector. The reference numeral 50 denotes a feedback device, which can correspond to an information providing device. The reference numeral 60 denotes a steering device. The reference numeral 61 denotes the steering shaft, which can correspond to a rotation shaft. The reference numeral 62 denotes the steering wheel, which can act a gripped part. The reference numeral 63 denotes the spoke, which can act a connection part. The reference numeral 70 denotes an in-vehicle apparatus, which can correspond to a controlled apparatus. The reference numeral 90 denotes the vehicle speed sensor, which can correspond to a traveling state detector.

The present disclosure has various aspects. For example, according to an aspect, an information input apparatus for detecting input information to output operation information to a controlled apparatus can be configured as follows. The information input apparatus includes a steering device that includes a rotation shaft, a grip part and at least two connection parts. The rotation shaft is supported rotatably around an axis line. The grip part is grippable by a driver and rotatable around the axis line to steer a vehicle. Each of the at least two connection parts connects the grip part and the rotation shaft, and enables transmission of vibration with the grip part. A driver of the vehicle can input the input information by tapping the grip part or the at least two connection part of the steering device of the vehicle. The information input apparatus further includes at least two measurement devices and a controller. The at least two measurement devices are mounted to the at least two connection parts, respectively, and are configured to measure the vibration propagating through the at least two connection parts, thereby outputting measurement signals, respectively. The controller pre-stores a correspondence between a form of the vibration, which is measured with the at least two measurement devices, and operation information directed to a controlled apparatus. From the pre-stored correspondence, the controller selects the operation information directed to the controlled apparatus, based on the measurement signals outputted from the at least two measurement devices. The controller outputs a control signal associated with the selected operation information.

According to the above configuration, the vibration generated in response to driver's tapping of the grip part or the connection parts is measured with the measurement devices mounted to the respective connection parts. Therefore, it is possible to easily mount the measurement devices. That is, the measurement devices for measuring the vibration propagating through the connection parts can be mounted in such a relatively simple way that, for example, the measurement device is adhered to a surface of the connection part. Thus, as compared with a known steering wheel input apparatus in which a piezoelectric sensor is embedded inside a grip part, the way of adhering the measurement device to the surface of the connection part can facilitate s mounting the measurement device. Furthermore, the measurement devices can be mounted without a change in configuration of the grip part or the connection parts, or with a relatively small change in the configuration of the grip part or the connection parts as compared with the case where the known steering wheel input apparatus.

Furthermore, according to the above configuration, based on the form of the vibration measured with the measurement devices, the controller selects the operation information directed to the controlled apparatus and outputs the control signal associated with the selected operation information. Therefore, a control signal associated with driver unintended operation information (intended by the driver) is prevented from being outputted to the controlled apparatus. Specifically, although the driver applies a force to the steering device in steering the vehicle, the controller is prevented from erroneously recognized as the operation information directed to the controlled apparatus and is prevented from outputting an erroneous control signal. For example, even when the driver applies a load to the grip part in turning the grip part, the controller does not output the control signal to the in-vehicle apparatus unless the connection part vibrates.

Furthermore, according to the above configuration, based on the form of the vibration measured with the at least two measurement devices, the controller selects the operation information directed to the controlled apparatus. Therefore, the controller can easily and accurately select the operation information directed to the controlled apparatus that the driver has intended. Specifically, the form of the vibration detected with one measurement device can be compared with the form of the vibration detected with another measurement device. Based on a result of this comparison, the controller can determine which of portions of the grip part or the connection parts the driver has tapped to generate the vibration. As a result, the controller can identify the operation information that the driver has inputted by tapping a particular portion of the grip part or the connection portions.

Furthermore, according to the above configuration, since the vibration is measured with the at least two measurement device positioned at respective places, the vibration travels a shorter distance before being measured, as compared with a case where a single sound wave measurement device at a single place measures a sound wave propagating through a steering wheel in clockwise direction and an anticlockwise direction. Therefore, the present information input apparatus can measure the vibration in a large amplitude state, can easily identify the operation information that the driver has intended.

Furthermore, according to the above configuration, the forms of the vibrations measured with the respective measurement devices are compared with each other. Additionally, the operation information is identified based on a result of the comparison. Thus, when the measured vibration contains noise such as vehicle vibration and the like for instance, the controller can reliably identify the driver intended operation information. For example, if pattern matching is performed on waveform of the measured sound wave in a manner like that in a comparison example, the noise in the measured sound wave makes it difficult to identify the driver intended operation information. In contrast to this comparison example, by comparing the forms of the vibrations detected with the respective measurement devices, the present information input apparatus can identity the driver intended operation information while suppressing an influence of the noise.

Examples of the controlled apparatus include a car audio apparatus, a portable music player, a car navigation system, a remotely-controllable door mirror, an air conditioner, a cruise control system, a power window, a wiper, an idle reduction system, and the like.

The operation information directed to the controlled apparatus includes information that instructs switching of the controlled apparatus between multiple apparatus, and information that allows setting of the controlled apparatus. Further, the operation information includes information that instructs the controlled apparatus to return from a first mode to a second mode. The first mode is, for example, a mode where the setting can be changed. The second mode is, for example, a mode where the controlled apparatus fulfills its function.

The above information input apparatus may be configured as follows. In the pre-stored correspondence, the form of the vibration measured with the at least two measurement devices is classified according to a driver tapped place of the grip part or the at least two connection parts, so that the correspondence between the classified form of the vibration and the operation information is determined.

According to the above configuration, multiple particular portions of the grip part or the connection parts can be associated with multiple contents of the operation information directed to the controlled target apparatus. Therefore, the driver can tap one of the multiple particular portions to input the corresponding operation information to the information apparatus, thereby instructing the controlled apparatus to perform an operation in accordance with the corresponding operatic information.

The above information input apparatus may be configured as follows. The form of the vibration measured with the at least two measurement devices is based on a temporal measurement order in which the at least two measurement devices measure the vibration. Specifically, the vibration generated at a driver tapped place is conducted along the grip part in a direction away from the tapped place, and then conducted from the grip part and the connection parts. Thereafter, the vibration is measured with the respective measurement devices. Thus, a path for the vibration to propagate before being measured can differ from one measurement device to another. As a result, a time of vibration measurement can differ from one measurement device to another. From this, when the time of vibration measurement differs, it can be determined that the driver has tapped the grip part.

When multiple measurement devices measure the vibration measurement at a same time, it can be determined that the driver has simultaneously tapped multiple connection parts to which the multiple measurement devices are mounted. In particular, if three or more measurement devices are mounted to respective three or more connection parts, it can be determine that the driver has tapped multiple connection parts at the same time. As described above, when the driver taps the gripped part, a path for the vibration to propagate before being measured differs from one measurement device to another, and as result, the time of vibration measurement differs from one measurement device to another. In contrast, when the driver taps multiple connection parts at the same time, the measurement devices mounted to the tapped multiple connection parts simultaneously measure the vibration. It should be noted that the measurement device mounted to an un-tapped connection part cannot measure the vibration or can measure only a weak vibration. This is because although the measurement device mounted to the un-tapped connection part is coupled with another connection part through the gripped part and the rotation shaft, a vibration conduction distance to another connection part is long and the vibration is difficult to conduct. Thus, when multiple measurement devices simultaneously measure the vibration, it can be determined that the driver has tapped the connection parts to which these multiple measurement devices are mounted. In the above, the simultaneous measurement of the vibration includes not only a completely simultaneous measurement with no time difference, but also a measurement with a predetermined time difference. The predetermined time difference represents, for example, a time difference that occurs when the driver taps two portions with both right and left hands with intention to simultaneously tap.

Since a path for the vibration to propagate before being measured differs from one measurement device to another, and since an amount of amplitude attenuation varies depending on path length, the amplitude of the vibration can vary depending on path. Thus, when the amplitudes of the vibrations measured with respective multiple measurement devices are different from each other, it can be determined that the driver has tapped a portion of the gripped part. Thus, the above information input apparatus may be configured such that the form of the vibration measured with the at least two measurement devices is based on a temporal measurement order in which the at least two measurement devices measure the vibration.

When the vibration with the same amplitude is measured with multiple measurement devices, it can be determined that the driver has simultaneously tapped multiple connection parts to which the multiple measurement devices are mounted. For example, when there are multiple measurement devices that have detected the vibration with the same amplitude and a measurement device that fails to measure the vibration, it can be determined that the driver has simultaneously tapped multiple connection parts to which the multiple measurement devices are mounted. In particular, if three or more measurement devices are mounted to respective three or more connection parts, it can be determine that the driver has tapped multiple connection part at the same time.

In the above, the same amplitude of the vibration includes not only completely-same amplitude with no amplitude difference, but also similar amplitude with a predetermined amplitude difference. The predetermined amplitude represents, for example, a difference in amplitude that occurs when the driver taps with both right and left hands with intention to tap two portions with the same magnitude. Moreover, a magnitude of amplitude of vibration may be determined based on a value of integral of amplitude, an maximum value of amplitude (half amplitude), a value between a maximum value and a minimum value of amplitude (total amplitude), or the like.

Alternatively, the above information input apparatus may be configured such that: when one or more of the measurement devices measures the vibration while the rest of the measurement devices fails to measure the vibration, the controller determines that the driver has tapped one or more of the connection parts to which the one or more of the measurement devices is mounted. Specifically, while a measurement device mounted to the tapped connection part can measure the vibration, another measurement device mounted to an un-tapped connection part cannot measure the vibration with a sufficient magnitude because conduction of the vibration to the un-tapped connection part is difficult. In view of this, the above configuration is provided.

The above information input apparatus may be configured such that each measurement device is mounted to a portion of the corresponding connection part, so that the each measurement device is arranged in the vicinity of the grip part. According to this configuration, for example, the measurement device becomes able to measure the vibration with larger amplitude as compared with a case where the measurement device is mounted in the vicinity of the rotation shaft. Since the vibration with larger amplitude can be measured at places closer to the tapped place, and since the grip part is a part to be tapped by the driver, the measurement device in the vicinity of the grip part can measure the vibration prior to attenuation of the generated vibration.

The above information input apparatus may be configured such that the measurement device is arranged on an upper surface of the connection part. According to this configuration, for example, the amplitude of the vibration measured with the measurement device can increase as compared with a case where a measurement device is arranged on a side surface of the connection part.

The above information input apparatus may further include an auxiliary part provided to increase an area through which the vibration can be conducted between the measurement device and the connection part. At a maximum, the area for vibration conduction may be increase to a facing surface of the measurement device and a facing surface of the connection part. The facing surface of the measurement device is a surface arranged to face the corresponding connection part. The facing surface of the connection part is a surface arranged to face the corresponding measurement device. For example, the auxiliary part may be arranged to conduct the vibration to the connection part and is in contact with the facing surface of the measurement device to conduct the vibration to the facing surface of the measurement device. With use of the auxiliary part, the measurement device can reliably measure the vibration of the connection part more reliably, as compared with a smaller area for vibration conduction.

The measurement device may include a piezoelectric element that converts the vibration of the connection part into an electric signal, an acceleration sensor that detects an acceleration caused by the vibration of the connection part, or the like. It may be preferable that the acceleration sensor detect the accelerations in two different directions.

The above information input apparatus may further include a selector to which selection information is inputted. The selection information is associated with selection of the controlled apparatus to which the operation information is inputted. When the selection information is inputted to the selector, the selector outputs a selection signal to the controller to switch the controlled apparatus. With use of the selector, it becomes possible to easily and reliably input the selection information for selecting the controlled apparatus

The above information input apparatus may further include a traveling state detector that detects a traveling state of the vehicle. Based on a detection signal inputted from the traveling state detector, the controller may control an output of the control signal to the controlled apparatus and a stop of the output of the control signal to the controlled apparatus. According to this configuration, the operation information can be inputted to the controlled apparatus only in a situation where the controlling of the controlled apparatus is acceptable, e.g., when the vehicle is stopped.

The above information input apparatus may further include an information providing device that provides the driver with information. When the controller receives an operational signal, which relates to an operational state of the controlled apparatus, from the controlled apparatus, the controller may output a control command to the information providing device, thereby instructing the information providing device to inform the driver of the operational state of the controlled apparatus. In this way, the driver can be easily informed of how the controlled apparatus has operated in response to the inputted operation information. For example, a manner of providing the drive with the operation state may include stimulation of auditory sense such as use of speech and the like, stimulation of tactile sense such as use of vibration and the like, and stimulation of visual sense such as light blinking, image display and the like.

Although the present disclosure has been fully described in connection with the above embodiments thereof with reference to the accompanying drawings, it is to be noted that various changes and modifications will become apparent to those skilled in the art.

What is claimed is:

1. An information input apparatus for detecting input information to output operation information to a controlled apparatus, wherein the input information is information that a driver of a vehicle inputs by tapping a grip part or a connection part of a steering device of the vehicle, the information input apparatus comprising:
a steering device that includes:
a rotation shaft which is supported rotatably around an axis line;
a grip part which is grippable by a driver and rotatable around the axis line to steer a vehicle; and
at least two connection parts each of which connects the grip part and the rotation shaft, and enables transmission of vibration with the grip part;
at least two measurement devices that are mounted to the at least two connection parts, respectively, and are configured to measure the vibration propagating through the at least two connection parts to thereby output measurement signals, respectively; and
a controller that
pre-stores a correspondence between a form of the vibration, which is measured with the at least two measurement devices, and operation information directed to a controlled apparatus, and
selects the operation information, which is directed to the controlled apparatus object, from the pre-stored correspondence based on the measurement signals outputted from the at least two measurement devices and outputs a control signal associated with the selected operation information.

2. The information input apparatus according to claim 1, wherein:
in the pre-stored correspondence, the form of the vibration measured with the at least two measurement devices is classified according to a driver tapped place of the grip part or the at least two connection parts, so that the correspondence between the classified form of the vibration and the operation information is determined.

3. The information input apparatus according to claim 1, wherein:
the form of the vibration measured with the at least two measurement devices is based on a temporal measurement order in which the at least two measurement devices measure the vibration.

4. The information input apparatus according to claim 1, wherein:
the form of the vibration measured with the at least two measurement devices is based on an amplitude magnitude order, which is an order of magnitude of amplitude of the vibration measured with the at least two measurement devices.

5. The information input apparatus according to claim 1, wherein:
when one or more of the at least two measurement devices measures the vibration while the rest of the at least two measurement devices fails to measure the vibration, the controller determines that the driver has tapped one or more of the connection parts to which the one or more of the at least two measurement devices is mounted.

6. The information input apparatus according to claim 1, wherein:
each of the at least two measurement devices is mounted to a portion of a corresponding one of the at least two connection parts, so that the each of the at least two measurement devices is arranged in the vicinity of the grip part.

7. The information input apparatus according to claim 1, wherein:
each of the at least two measurement devices is arranged on an upper surface of a corresponding one of the at least two connection parts.

8. The information input apparatus according to claim 1, wherein:
each of the at least two measurement devices includes a piezoelectric element that converts the vibration of a corresponding one of the at least two connection parts into an electric signal.

9. The information input apparatus according to claim 1, wherein:
each of the at least two measurement devices includes an acceleration sensor that detects an acceleration caused by the vibration of a corresponding one of the at least two connection parts.

10. The information input apparatus according to claim 9, wherein:
the acceleration sensor detects the accelerations in two different directions.

11. The information input apparatus according to claim 1, further comprising:
a selector to which selection information is inputted from the driver,
wherein:
the selection information is associated with selection of the controlled apparatus to which the operation information is inputted; and
when the selection information is inputted to the selector, the selector outputs a selection signal to the controller to switch the controlled apparatus.

12. The information input apparatus according to claim 1, further comprising:
a traveling state detector that detects a traveling state of the vehicle,
wherein:
based on a detection signal inputted from the traveling state detector, the controller controls an output of the control signal to the controlled apparatus and a stop of the output of the control signal to the controlled apparatus.

13. The information input apparatus according to claim 1, further comprising:
an information providing device that provides the driver with information,
wherein:
when the controller receives an operational signal, which relates to an operational state of the controlled apparatus, from the controlled apparatus, the controller outputs a control command to the information providing device instructing the information providing device to inform the driver of the operational state of the controlled apparatus.

14. The information input apparatus according to claim 1, wherein:
the operation information includes information associating with switching of the controlled apparatus to be controlled, and information associated with switching of a control mode of the controlled apparatus.

15. The information input apparatus according to claim 1, wherein:
each measurement device includes a facing surface arranged to face the corresponding connection part;
each connection part includes a facing surface arranged to face the corresponding measurement device; and
the facing surface of each measurement device is larger than the facing surface of the corresponding connection part,
the information input apparatus further comprising:
an auxiliary part that is arranged to conduct the vibration to each connection part and is in contact with the facing surface of the corresponding measurement device to conduct the vibration to the facing surface of the corresponding measurement device.
